(19) United States
(12) Patent Application Publication
(10) Pub. No.: US 2005/0271964 A1
(43) Pub. Date: Dec. 8, 2005

(54) Toner coated with thin film

(75) Inventors: Kei Etou, Tokyo (JP); Hisano Higurashi, Tokyo (JP); Yusuke Nakayama, Tokyo (JP); Kaori Ezaki, Tokyo (JP); Toru Kimura, Tokyo (JP)

Correspondence Address: FITCH, EVEN, TABIN & FLANNERY, P. O. BOX 65973, WASHINGTON, DC, 20035, US

(73) Assignee: Toppan Forms Co., Ltd., Minato-ku, Tokyo (JP)

(21) Appl. No.: 10/525,374

(22) PCT Filed: Aug. 21, 2003
(86) PCT No.: PCT/JP03/10592

§ 371 Date: Feb. 23, 2005

(30) Foreign Application Priority Data
Aug. 23, 2002 (JP) 2002-243505
Oct. 22, 2002 (JP) 2002-306897
Mar. 25, 2003 (JP) 2003-82784
Mar. 25, 2003 (JP) 2003-82785
Mar. 25, 2003 (JP) 2003-82786

(51) Int. Cl. G03G 9/093

(52) U.S. Cl. 430/110.2; 430/110.1; 430/137.14; 430/137.15; 430/111.4

(57) ABSTRACT

Satisfactory anti-blocking property of powder toner can be realized, while avoiding increase in softening temperature of the powder toner, by coating the surface of a low melting point powder toner with a thermosetting resin. This leads to the realization of toner fixing at lower temperatures and is particularly effective when using a urea resin as the thermosetting resin or employing polymerized toner as the powder toner. Use of the surface-coated powder toner with a low softening temperature and less blocking tendency makes possible reduction of thermal energy and time required for fusing, thereby realizing energy-saving and high-speed fusing process.

### TECHNICAL FIELD

The present invention relates to powder toner coated with a resin thin film, in particular, to toner fusible at lower temperatures.

### BACKGROUND ART

Several methods have been proposed and put to practical use for fusing or fixing developers in an electrophotographic printing process, such as contact fusing methods using a heat roll etc., non-contact fusing methods such as flash fusing, contact pressure fixing methods using a pressure roll etc., and contact heat pressure fusing methods using a heat pressure roll etc.

In heat fusing methods, such as contact fusing methods, non-contact fusing methods or contact heat pressure fusing methods, of the above described fusing or fixing methods, the fusing temperature is determined depending mainly on the softening temperature of the toner used. If the softening temperature of the toner is sufficiently low, the fusing temperature can be lowered that much. If the fusing temperature is sufficiently low, the amount of thermal energy and time required for fusing can be reduced, whereby an energy-saving and high-speed fusing process can be realized. From this viewpoint, for example, low melting point toner which softens at low temperatures is being developed.

A flash fusing method has been actively developed in recent years because it allows high-speed fusing since toner is heated momentarily by infrared irradiation (flash firing), and besides, it decreases deterioration of substrates onto which toner is fused since it is a non-contact method, and the method is being employed in high-speed variable printer etc.

There are many prior art documents on the flash fusing method. For example, Japanese Patent Laid-Open No. 2002-182432 describes the recent trend of the development of the method.

Toner for realizing high-speed fusing has also been actively developed, besides the flash fusing method. To realize high-speed fusing in the heat fusing method, toner with a low softening temperature has been developed. If toner softens at low temperatures, the toner can be fused by a small amount of heat, which enables high-speed fusing.

However, when using toner with a low softening temperature, the toner particles may coalesce with each other, causing the toner to significantly deteriorate in conveyability and to suffer blocking, which can sometimes make the toner unusable.

In the mean time, when using toner with a high softening temperature, the toner is less likely to show a blocking tendency and offers good conveyability; however, in heat roll fusing, for example, the fusing temperature is required to be increased to realize sufficient fusing. Further, fusing can sometimes require a longer time because it is necessary to ensure sufficient time for the substrate, onto which the toner has adhered, to pass through a nip. Still further, to realize high-speed fusing in the flash fusing method, it is necessary to expose the toner to highly intensive flashlight, which means consumption of a large amount of energy and may cause deterioration of the substrate. Thus, high-speed fusing has some technical limitations.

One of the possible means of providing toner with a less coalescing tendency (less blocking tendency) and a high-speed fusing property at the same time is to use capsule toner, which is toner whose particles are included in capsules. Since the surface of capsule toner is a capsule resin wall, even if binder resin that softens at low temperatures is used, toner particles hardly coalesce with each other and the toner hardly suffers blocking, which allows the use of binder resin that softens at sufficiently low temperatures and even allows the use of a liquid that contains a coloring material.

However, in cases where the material included in capsules is a liquid, a problem might arise of scattering the material included in capsules when the capsule resin wall breaks during the conveyance of the toner. In cases where the material included in capsules is resin, few methods have been proposed for coating each toner particle independently with thin film resin while avoiding changes in the particle size distribution of the toner. Although there have been proposed a number of methods for encapsulating solid matter, such as resin, as described in, for example, KONDOH Tamotsu and KOISHI Masumi, Microcapsule—Its Production Method, Character and Applications, Sankyo Shuppan, 1997, 30-42, most of them are related to multi-core microcapsules. Thus, toner having a desired particle size distribution is hard to produce.

Another possible means of providing toner with a less coalescing tendency (less blocking tendency) and a high-speed fusing property at the same time is to use surface-coated toner. In surface-coated toner, the toner particles hardly coalesce and the toner hardly suffers blocking even when binder resin that softens at low temperatures is used, because its surface is a resin wall. Thus, binder resin that softens at sufficiently low temperatures can be used, and besides a liquid that contains a coloring material can also be used.

For example, Japanese Patent Laid-Open Nos. 55-070853 and 58-111050 describe capsule toner whose outer shell is made up of melamine resin, urea resin and the like. Japanese Patent Laid-Open No. 59-166966 describes capsule toner whose outer shell is made up of urethane resin and the like. However, the inventors of these types of toner intended to use the toner in contact pressure methods such as pressure fixing and did not understand a blocking tendency of toner as a technological problem which would confront them. The specifications include only examples where liquid materials are used as the core of the capsule toner. Japanese Patent Laid-Open Nos. 57-104148, 61-122656, 09-054455 and 09-006039 describe toner using melamine resin. However, in these inventions, melamine is not resinified on the surface of the toner, but melamine having been resinified prior to the preparation of the toner is used. Thus, it is hard to think that the surface of the toner is substantially coated with a thin film.

As described so far, it appears that no toner has been developed yet which is produced by first dispersing toner particles in a medium while keeping the same in the solid state and then allowing encapsulization reaction to progress while keeping the above state so as to apply coating onto the toner, which is suitably used in contact fusing methods such as heat fusing using a heat roll or non-contact fusing methods such as flash fusing, and which shows a less blocking tendency.

In conventional toner, toner particles diffuse into the substrate at high speed during heat fusing or flash fusing process, whereby the resultant resolution can sometimes be insufficient. This tends to be noticeable when olefin resin is used as binder resin.

Further, when the surface of toner is coated with a surface film, the toner shows a less blocking tendency, indeed; however, when a surface film is formed which can realize a sufficient anti-blocking property, the softening point of the surface-coated toner can sometimes be raised. Thus, the surface-coated toner sometimes has a high softening point, though it is formed by applying a surface film onto the surface of toner having a low softening point, and its fusing process sometimes requires high temperature.

Thus, though there have been made many attempts to apply coating onto the surface of toner, it is hard to provide toner with a sufficient anti-blocking property and a low-temperature fusing property at the same time.

Toner whose surface is coated with a thermosetting resin has improved in blocking tendency. However, even when using toner whose surface is coated with a thermosetting resin, the toner conveyability is still insufficient and the resolution of the formed image is also sometimes insufficient.

The present inventors have directed tremendous research efforts toward understanding the causes of such problems and have found that the shape of toner is one of the causes. Specifically, if toner has low true sphericity, low roundness or extreme surface unevenness, toner conveyability or resolution of formed image sometimes becomes insufficient.

The problems associated with the shape of toner may occur in both ground toner and polymerized toner; however, ground toner more tends to have low true sphericity, low roundness or extreme surface unevenness. Further, comparing ground toner with polymerized toner, generally the production method is easier and production cost is lower for ground toner. For these reasons, there have been demands that the shape of ground toner should be controlled.

Toner used in an electrophotographic printing process is divided into two major types: ground toner and polymerized toner. Ground toner is produced by fusing and mixing various constituents of toner into binder resin, grinding the mixture, and classifying the grinded particles to yield fine particles. Polymerized toner is produced by polymerizing monomers by means of emulsion polymerization, suspension polymerization or dispersion polymerization and creating particulate binder resin that contains various constituents of toner.

Of the above two types of toner, the use of toner produced by means of polymerization has been often proposed in recent years, and polymerized toner is being put to practical use seriously because it has an excellent performance as a developer for electrophotography. Use of toner secondary particles, which are prepared by aggregating toner primary particles to form aggregates, is also proposed in, for example, Japanese Patent Laid-Open Nos. 05-265252 and 06-329947. Polymerized and aggregated toner thus obtained also has an excellent performance as a developer for electrophotography and is being put to practical use.

However, in polymerized toner, too, it is generally difficult to provide the toner with a less tendency to coalesce (an anti-blocking property or less blocking tendency) and a high-speed fusing property at the same time. Thus, despite its high performance, polymerized toner sometimes gives rise to problems and its performance cannot sometimes be made full use of.

Also for polymerized and aggregated toner, too, it is generally difficult to provide the toner with a less tendency to coalesce (anti-blocking property or less blocking tendency) and a high-speed fusing property at the same time. Thus, despite its high performance, polymerized and aggregated toner sometimes gives rise to problems and its performance cannot sometimes be made full use of.

### DISCLOSURE OF THE INVENTION

In the light of the above described circumstances, an object of the present invention is to provide powder toner with a less tendency to coalesce (less blocking tendency) and a high-speed fusing property at the same time, realize a desired average particle size and particle size distribution of powder toner, and realize powder toner whose surface is substantially continuously coated with a thin film that contains a thermosetting resin.

Another object of the present invention is to inhibit toner from diffusing too much into the substrate during heat fusing and flash fusing processes, thereby realizing high resolution of formed images.

Another object of the present invention is to realize sufficient anti-blocking property in toner, while avoiding greatly raising the softening temperature of the toner, by the application of coating onto the surface of toner with a low softening temperature, thereby providing surface-coated toner that is fusible at low temperatures and has less blocking tendency at the same time.

Still another object of the present invention is to realize toner fusing at sufficiently low temperatures and reduce the thermal energy and time required for fusing by using surface-coated toner that is fusible at low temperatures and has less blocking tendency at the same time, thereby realizing an energy-saving and high-speed fusing process.

Still another object of the present invention is to provide toner which has sufficiently high true sphericity, sufficiently high roundness and less surface unevenness and whose surface is coated with a thermosetting resin, thereby realizing sufficient toner conveyability and sufficient resolution of formed images.

Still another object of the present invention is to produce toner which has sufficiently high true sphericity, sufficiently high roundness and less surface unevenness and whose surface is coated with a thermosetting resin conveniently, at low cost and at good productivity.

Another object of the present invention is to provide polymerized toner with a less tendency to coalesce (anti-blocking property or less blocking tendency) and low-temperature fusing property at the same time.

Another object of the present invention is to realize sufficient anti-blocking property in polymerized toner that softens at low temperatures, while avoiding greatly raising the softening temperature of the toner, particularly by applying coating onto the surface of the polymerized toner, thereby providing polymerized toner with low-temperature fusing property and less blocking tendency at the same time.

Fusing at sufficiently low temperatures is realized by using polymerized toner that softens at low temperatures and has less blocking tendency, whereby the thermal energy and time required for fusing are reduced and a saving-energy and high-speed fusing process is realized.

Another object of the present invention is to provide polymerized and aggregated toner with a less tendency to coalesce (anti-blocking property or less blocking tendency) and low-temperature fusing property at the same time.

Another object of the present invention is to realize sufficient anti-blocking property in polymerized and aggregated toner that softens at low temperatures, while avoiding greatly raising the softening temperature of the toner, particularly by applying coating onto the surface of the polymerized and aggregated toner, thereby providing polymerized and aggregated toner with low-temperature fusing property and less blocking tendency at the same time.

Fusing at sufficiently low temperatures is realized by using polymerized and aggregated toner that softens at low temperatures and has less blocking tendency, whereby the thermal energy and time required for fusing are reduced and saving-energy and high-speed fusing process is realized.

To achieve the above described objects, the present invention provides a thin-film coated toner that is a powder toner with a softening temperature ranging from 40 to 150° C. whose surface is coated substantially continuously with the thin film comprising a thermosetting resin.

The present invention also provides the above-mentioned thin-film coated toner, whose fusing temperature is 145° C. or lower.

The present invention also provides the above-mentioned thin-film coated toner, wherein the thermosetting resin is a urea-base resin or a melamine-base resin.

The present invention also provides the above-mentioned thin-film coated toner, wherein the urea-base resin is formed by resinifying a precursor of a concentrated urea-base resin on the surface of the powder toner while avoiding fusing the powder toner.

The present invention also provides the above-mentioned thin-film coated toner, wherein the urea-base resin is formed by resinifying a urea-base resin precursor mixture which comprises at least either one of a urea and a urea derivative and at least either one of a formaldehyde and a formaldehyde derivative on the surface of the powder toner, while avoiding fusing the powder toner.

The present invention also provides the above-mentioned thin-film coated toner, wherein an average film thickness of the thin film is 0.005 to 1 μm.

The present invention also provides the above-mentioned thin-film coated toner, wherein the powder toner is a polymerized toner.

The present invention also provides the above-mentioned thin-film coated toner, wherein the polymerized toner is a polymerized toner secondary particle formed by an aggregation of a polymerized toner primary particle.

The present invention also provides the above-mentioned thin-film coated toner, wherein a true sphericity (DSF) defined by the following formula I is 0.85 or more;
DSF=m/M I
wherein m represents a minimum diameter of a projection drawing of the toner and M represents a maximum diameter of the projection drawing of the same.

The present invention also provides a method for producing a thin-film coated toner, comprising steps of:
dispersing a powder toner in a solid state in a water-base medium in which a dispersant is dissolved;
mixing a monomer or a pre-polymer of a thermosetting resin into the dispersion; and
resinifying the raw material while avoiding fusing the powder toner, and coating a surface of the powder toner with the thin film comprising the thermosetting resin.

The present invention also provides a method for producing a thin-film coated toner, comprising steps of:
emulsion-polymerizing a toner ingredient that comprises a binder resin monomer as a raw material for a binder resin to prepare a dispersion of a powder toner;
mixing a monomer of a thermosetting resin or a pre-polymer of a thermosetting resin as a raw material for the thermosetting resin into the dispersion of the powder toner; and
resinifying the monomer of the thermosetting resin or the pre-polymer of the thermosetting resin while avoiding fusing the powder toner, and coating a surface of the powder toner with the thin film comprising the thermosetting resin.

The present invention also provides the above-mentioned method for producing the thin-film coated toner, further comprising a step of aggregating the powder toner.

The present invention also provides the above-mentioned method for producing the thin-film coated toner, further comprising a step of heating the powder toner in a temperature range that causes no thermal breakage of the thin film to fuse the powder toner.

### BRIEF DESCRIPTION OF THE DRAWINGS

FIGS. 1(a) and 1(b) are electron micrographs of the toner.

FIG. 2 is a schematic view illustrating thin-film coated toner, where reference numeral 20 denotes toner and numeral 21 the same toner drawn in projection.

FIG. 3 is a schematic view illustrating thin-film coated toner, where reference numeral 10 denotes toner and numeral 11 the same toner drawn in projection.

FIGS. 4(a) and 4(b) are electron micrographs of the toner.

FIG. 5 is a schematic view illustrating a method for coating the surface of primary particles of polymerized toner with thermosetting resin thin film, where reference numeral 11 denotes primary particles of toner and numeral 31 surface thin film.

FIG. 6 is a schematic view illustrating a method for coating the surface of secondary particles of polymerized toner with thermosetting resin thin film, where reference numeral 10 denotes primary particles of toner, numeral 20 a secondary particle of the same and numeral 30 surface thin film.

### BEST MODE FOR CARRYING OUT THE INVENTION

In the following the present invention will be described in detail.

(Thin-Film Coated Toner)

In the present invention, thin-film coated toner is preferably such that its surface is substantially continuously coated with a thin film that contains a thermosetting resin, the toner before coated with the thin film is in the form of powder, and the toner before coated with the thin film has a softening temperature ranging from 40 to 150° C.

The term “substantially continuously” herein used means that the state of the thin-film coating is not that of a coating formed from a powder coating material in the fused state, and there does not exist so many discontinuities in the thin-film coating as will cause the deterioration of toner performance. The state can be ascertained by an electron microscope etc. The coating of the present invention is allowed to be substantially continuous because it is formed by resinifying its raw material on the solid surface.

The thin-film coated toner as described above can be suitably produced by a method that includes:
a step of dispersing powder toner in the solid state in a water-base medium where a dispersant is dissolved;
a step of mixing monomer or prepolymer of a thermosetting resin into the above dispersion; and
a step of resinifying the ingredient, while avoiding fusing the powder toner, to coat the surface of the powder toner with thin film containing the thermosetting resin.

According to the above described production method, first toner in the solid state is dispersed in a water-base medium where a dispersant is dissolved. Then, the raw material for a thermosetting resin, which is to become coating film, is added to the above dispersion and resinified on the surface of the toner in the solid state. This allows the individual toner particles to be coated with thermosetting-resin thin film. The formed thermosetting-resin film is sufficiently thin and coats the surface of each toner particle substantially continuously.

In this case, if the resin thin film is taken as a resin capsule wall, each microcapsule can be taken as a single-core microcapsule that contains a single fine toner particle. Even if the toner has a low softening temperature, the toner particles can be inhibited from coalescing with each other since the surface of each toner particle is coated with a thermosetting-resin thin wall.

Further, if the resin thin film that coats the surface of each toner particle is sufficiently thin, the average particle size and the particle size distribution of toner hardly change before and after thin-film coating. Thus, if the toner before thin-film coating has desired average particle size and particle size distribution, the resultant thin-film coated toner also has desired average particle size and particle size distribution.

Accordingly, if the thin-film coated toner as describe above is used, less coalescing tendency (less blocking tendency) and a high-speed fusing property of toner can be compatible with each other, and desired average particle size and particle size distribution of the toner can be realized.

The above described method is available for applying a coating onto either one of ground toner and polymerized toner. However, in polymerized toner produced by emulsion polymerization, for example, if the surface of the polymerized toner is coated with a thermosetting resin subsequently after the emulsion polymerization, the polymerized toner need not undergo separation and purification prior to the coating process, and thus good productivity and performance can be realized.

Specifically, the thin-film coated toner as described above can be suitably produced by a method that includes:
a step of emulsion polymerizing toner ingredients that include binder resin monomer as a raw material for a binder resin to prepare a dispersion of toner;
a step of mixing monomer or prepolymer of a thermosetting resin as a raw material for the thermosetting resin into the dispersion of powder toner; and
a step of resinifying the monomer or prepolymer of the thermosetting resin, while avoiding fusing the toner, to coat the surface of the toner with thin film containing the thermosetting resin.

The monomer or prepolymer of a thermosetting resin is a raw material for the thermosetting resin, and the partial polymer of the monomer, the prepolymer of the monomer and the mixture thereof can also be used.

The thin-film coated toner is recovered by means of sedimentation, cleaned and heat dried, after coating process, depending on the situation.

Further, the heat dried thin-film coated toner is grinded depending on the situation.

According to the method as described above, powder toner is provided with a less tendency to coalesce (less blocking tendency) and a high-speed fusing property at the same time, desired average particle size and particle size distribution of the powder toner can be realized, and powder toner whose surface is coated substantially continuously with thin film that contains a thermosetting resin can be produced in good productivity.

The thin-film coated toner not only has an excellently less coalescing tendency (less blocking tendency), but also has a softening temperature as low as 40 to 150° C. Thus, the thin-film coated powder toner of this invention is suitably used particularly in contact fusing methods such as heat fusing that uses a heat roll and non-contact fusing methods such as flash fusing.

Further, in the powder toner of this invention, toner particles as a core material are inhibited from diffusing into the substrate during heat fusing process, flash fusing process, etc. since its surface is coated substantially continuously with thermosetting-resin thin film, whereby high resolution of formed images can be realized. This excellent character of the powder toner is noticeable particularly when olefin resin is used as a binder resin.

(Coating Resin)

The thin film that coats the surface of toner is probably an anti-blocking film, and the resin used for forming such coating thin film is not limited to any specific one as long as it can provide toner with a less tendency to coalesce (less blocking tendency) and a high-speed fusing property at the same time and can realize desired average particle size and particle size distribution of the toner. However, the thin film should be such that it can be formed by feeding its resin material to the reaction site exclusively from the water-base medium, since the film is formed on toner in the solid state. Specifically, thin film formed by in-situ polymerization, submerged setting or coacervation is preferable. From the view point of reactivity, film formed by in-situ polymerization is particularly preferable. In in-situ polymerization, the raw material for resin film exists only in a water-base medium. The raw material reacts and is resinified on toner fine particles, thereby forming coating film.

The type of resin that constitutes coating film is not limited to any specific one as long as it can form the coating film by one of the methods described above. However, because of their capability of sufficiently inhibiting the coalescence of toner and their excellent film forming ability, melamine resins, urea resins such as urea resorcin resin, urethane resins, amide resins, olefin resins and gelatin-gum arabic resins are used. Because of their low susceptibility to water and excellent storage stability, melamine resins and urea resins such as urea resorcin resin are preferable. Melamine resins and urea resins such as urea resorcin resin inhibit thin-film coated toner from coalescing while the toner is being dried, since they have a low susceptibility to water, and therefore they can also inhibit the change of average particle size and particle size distribution of the toner. Besides, they are not decayed during storage.

Specifically, when forming coating film from a melamine resin, for example, in-situ polymerization using a methylolated melamine compound can be employed.

When forming coating film fromaurea resin, for example, in-situ polymerization using a methylolated urea compound can be employed.

When forming coating film from a urethane resin, for example, in-situ polymerization using an amino-carbonyl monoxy compound can be employed.

When forming coating film from an amide resin, for example, in-situ polymerization using an amino acid derivative can be employed.

When forming coating film from an olefin resin, for example, in-situ polymerization using ethylene, propylene, styrene, (meth)acrylic acid, (meth)acrylate ester, vinyl acetate, or styrene-divinylbenzene or the like can be employed.

Although the above described resins include resins other than thermosetting resins, the non-coherent resins can also be used depending on the situation.

When sufficiently thin coating film is formed on individual toner particles using any one of the above described resins, the difference in the average particle size and particle size distribution of the toner is very small before and after the coating. From the view point of ease of production, the volume average particle size of toner before coating is preferably 0.1 μm or more, more preferably 0.5 μm or more and much more preferably 1 μm or more. Meanwhile, from the viewpoint of the resolution of formed images, the volume average particle size of toner before coating is preferably 20 μm or less, more preferably 15 μm or less and much more preferably 10 μm or less. Likewise, the volume average particle size of toner after coating is, from the viewpoint of ease of production and recoverability of thin-film coated toner after coating, preferably 0.1 μm or more, more preferably 0.51 μm or more and much more preferably 1 μm or more. Meanwhile, from the viewpoint of the resolution of formed images, the volume average particle size of toner after coating is preferably 20 μm or less, more preferably 15 μm or less and much more preferably 10 μm or less. The volume average particle size and particle size distribution of toner can be measured using, for example, Coulter Multisizer manufactured by Coulter Electronics (U.K.).

The average thickness of the thin film coated on toner can be arithmetically calculated using the average particle sizes of the toner before and after coating. It can also be measured by cutting thin-film coated toner while fixing the same in an epoxy resin etc. and observing the cross section with an electron microscope. From the view point of sufficient inhibition of coalescence of toner particles, the average film thickness measured as above is preferably 0.005 μm or more, more preferably 0.01 μm or more and much more preferably 0.02 μm or more. Meanwhile, to allow the average particle size and particle distribution of toner after coating to fall in the desired range, the average film thickness is preferably 0.1 μm or less, more preferably 0.08 μm or less and much more preferably 0.05 μm or less.

The average film thickness can sometimes be 1 μm or less or 0.5 μm or less, depending on the situation, on the ground of toner performance required.

(Toner Whose Surface is Coated with Urea Resin)

Of the above described types of thin-film coated toner, preferable is toner whose surface is coated with urea resin thin film that is formed by resinifying a concentrated precursor of a urea resin on the surface of the toner, while avoiding fusing the toner.

Also preferable is toner whose surface is coated with urea resin thin film that is formed by resinifying a mixture of a urea resin precursor containing at least either one of urea and a urea derivative and at least either one of formaldehyde and a formaldehyde derivative on the surface of the toner, while avoiding fusing the toner.

The term “fusing” herein used means the state in which toner is completely fused or liquefied by heating and it does not mean the softening or thermal deformation of toner. The reason is that even if toner is partially fused by heating, as long as the partial fusing is to such an extent that it can be referred to as softening or deformation, coating film can be formed on the surface of the toner.

The term “resinification” herein used means not only complete resinification where polymerization degree is high enough, but also partial resinification where polymerization degree is medium. The term means the formation of polymer whose polymerization degree is high enough to inhibit the coalescence of toner particles.

Coating the surface of toner having a sufficiently low softening temperature with a urea resin makes it possible to realize a sufficient anti-blocking property of the toner while avoiding a great increase of the softening point of the toner, thereby realizing surface-coated toner that has a low fusing temperature and less blocking tendency at the same time.

Specifically, coating the surface of toner with a urea resin makes it possible to keep the fusing temperature increase created by coating preferably 20° C. or less, more preferably 15° C. or less and much more preferably 10° C. or less.

It also makes it possible to keep the fusing temperature of the resultant thin-film coated toner preferably 145° C. or less, more preferably 125° C. or less and much more preferably 100° C. or less.

Use of such surface-coated toner, that is, toner having a low fusing temperature and less blocking tendency at the same time makes it possible to realize fusing at a sufficiently low temperature and reduce the thermal energy and time required for fusing, thereby realizing energy-saving and high-speed fusing process.

More specifically, use of such surface-coated toner makes it possible to realize fusing at a sufficiently low temperature and reduce the thermal energy and time required for fusing, thereby realizing energy-saving and high-speed fusing process in heat fusing methods, such as contact fusing methods using a heat roll etc., non-contact fusing methods such as flash fusing and contact heat pressure fusing methods using a heat roll etc.

Such surface-coated toner is preferably such that its surface is coated substantially continuously with thin film containing a urea resin. Substantially continuous coating film can be formed by resinifying the raw material for the film on the surface of solid toner.

Substantially continuous coating film can be formed by resinifying the raw material for the film on the surface of solid toner.

Specifically, substantially continuous coating film can be formed by a method that includes:
a step of dispersing powder toner in the solid state in a water-base medium where a dispersant is dissolved;
a step of mixing a concentrated precursor of a urea resin or a mixture of a urea resin precursor into the dispersion; and
a step of resinifying the concentrated precursor of a urea resin or the mixture of a urea resin precursor, while avoiding fusing the powder toner, to coat the surface of the powder toner with thin film containing the urea resin.

According to the above described production method, first toner in the solid state is dispersed in a water-base medium where a dispersant is dissolved. Then, the raw material for a urea resin, which is to become coating film, is added to the above dispersion and resinified on the surface of the toner in the solid state. This allows the individual toner particles to be coated with urea resin thin film. The formed urea resin film is sufficiently thin and coats the surface of each toner particle substantially continuously.

In this case, if the resin thin film is taken as a resin capsule wall, each microcapsule can be taken as a single-core microcapsule that contains a single fine toner particle. Even if toner has a low softening temperature, the toner particles can be inhibited from coalescing with each other since the surface of each toner particle is coated with a urea resin thin wall.

The above described method is available for applying a coating onto either one of ground toner and polymerized toner. However, in polymerized toner produced by emulsion polymerization, for example, if the surface of the polymerized toner is coated with a urea resin subsequently after the emulsion polymerization, the polymerized toner need not undergo separation and purification prior to the coating process, and thus good productivity and performance can be realized.

Specifically, the thin-film coated toner as described above can be suitably produced by a method that includes:
a step of emulsion polymerizing toner ingredients that include binder resin monomer as a raw material for a binder resin to prepare a dispersion of toner;
a step of mixing a concentrated precursor of a urea resin or a mixture of a urea resin precursor as a raw material for the urea resin into the dispersion of powder toner; and
a step of resinifying the concentrated precursor of a urea resin or the mixture of a urea resin precursor, while avoiding fusing the toner, to coat the surface of the toner with thin film containing the urea resin.

The thin-film coated toner is recovered by means of sedimentation, cleaned and heat dried, after coating process, depending on the situation.

Further, the heat dried thin-film coated toner is grinded depending on the situation.

To provide powder toner with a sufficient anti-blocking property and a low-temperature fusing property at the same time, the surface coating film is formed by resinifying a concentrated precursor of a urea resin or a mixture of a urea resin precursor.

The concentrated precursor of a urea resin herein means a partial condensation product of at least either one of urea and a urea derivative and at least either one of formaldehyde and a formaldehyde derivative in which the concentration of the resin ingredient has been adjusted to a prescribed value.

From the viewpoint of performance of the resultant urea-resin coated toner, preferably urea and formaldehyde are partially condensed.

From the viewpoint of realization of a sufficient anti-blocking property of the urea-resin coated toner, the amount of at least either one of formaldehyde and a formaldehyde derivative used for the partial condensation is preferably 1.5 parts by mole or more per 1 part by mol of at least either one of urea and a urea derivative, more preferably 1.7 parts by mol or more and much more preferably 1.8 parts by mol or more. Meanwhile, from the viewpoint of realization of a sufficiently low-temperature fusing property of the urea-resin coated toner, the amount of at least either one of formaldehyde and a formaldehyde derivative used for the partial condensation is preferably 2.5 parts by mole or less per 1 part by mol of at least either one of urea and a urea derivative, more preferably 2.3 parts by mol or less and much more preferably 2.2 parts by mol or less.

The concentration of the resin ingredient after partial condensation is preferably 50% by mass or more and more preferably 55% by mass or more from the view point of realization of a sufficient anti-blocking property of the urea-resin coated toner, whereas from the viewpoint of realization of a sufficiently low-temperature fusing property of the urea-resin coated toner, it is preferably 70% by mass or less and more preferably 65% by mass or less.

The mixture of a urea resin precursor contains at least either one of urea and a urea derivative and at least either one of formaldehyde and a formaldehyde derivative.

Depending on the situation, a co-condensed urea resin is sometimes preferably used in which a monomer ingredient other than urea, a urea derivative, formaldehyde and a formaldehyde derivative is also co-condensed.

Examples of ingredients used for the co-condensation include divalent alcohols such as hydroquinone, resorcin, dihydroxynaphthalene and bisphenol.

Of the above described ingredients, non-colorable co-condensation ingredients are preferable. From this viewpoint, hydroquinone, dihydroxynaphthalene, bisphenol, and the like are preferable. The urea-resin coating film for coating the surface of powder toner which is formed using any of these co-condensation ingredients is preferable because it is stable during the coating process and toner fusing process and less colored.

To form coating film on the surface of toner in the solid state, a method is employed in which the raw material for a urea resin is fed to the reaction site exclusively from the water-base medium. Specifically, the coating film is formed preferably by in-situ polymerization, submerged setting, coacervation or the like. From the viewpoint of reactivity, in-situ polymerization is preferably used. In in-situ polymerization, the raw material for a urea resin reacts and is resinified on the toner particles and forms coating film on them.

(Shape of Toner)

Preferred toner is such that it includes 70% by mass or more of toner particles with a sphericity (DSF) defined by the following formula I of 0.85 or more and its surface is coated with a thin film containing a thermosetting resin.
DSF=m/M I

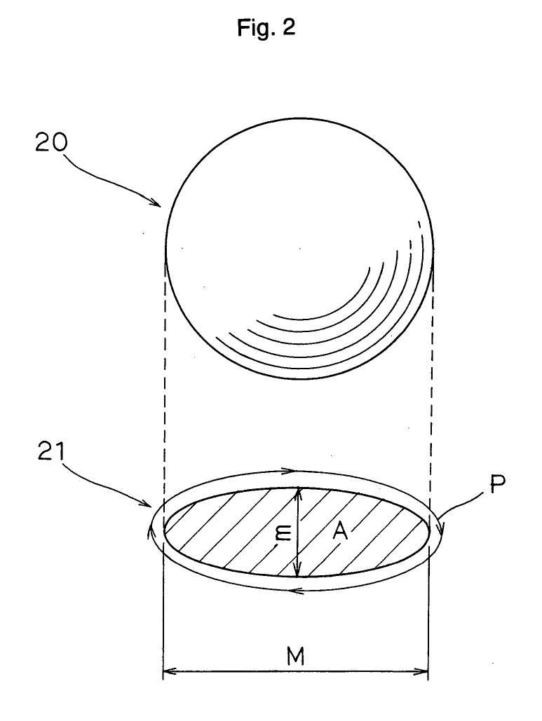

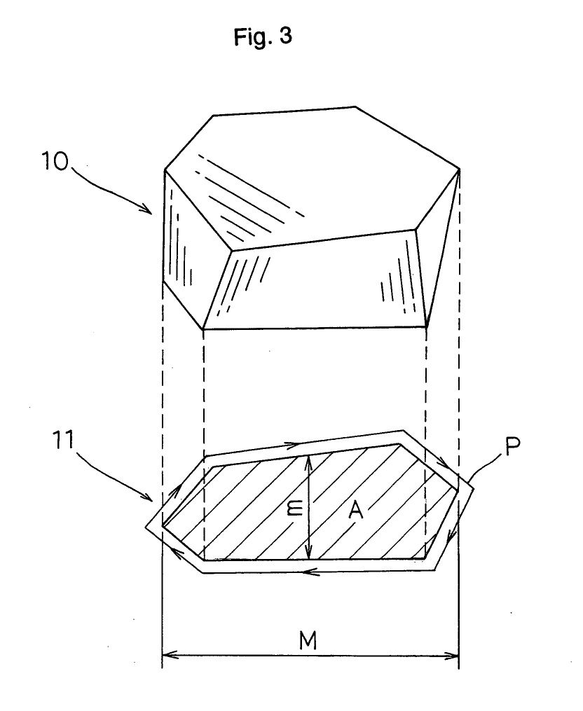

FIGS. 2 and 3 are schematic views illustrating thin-film coated toner. Reference numeral 20 of FIG. 2 and numeral 10 of FIG. 3 each denote toner drawn in perspective and reference numeral 21 of FIG. 2 and numeral 11 of FIG. 3 each denote toner drawn in projection.

As shown in Figures, m denotes the minimum diameter of the toner drawn in projection and M the maximum diameter of the same. The more the shape of toner is controlled and the higher the sphericity of the toner becomes, the larger the value DSF becomes and the closer the value becomes to 1, leading to high percentage of toner particles with a DSF of 0.85 or more.

Use of toner whose particles have a sufficiently high sphericity (DSF) and whose surface is coated with a thermosetting resin makes possible the realization of satisfactory toner conveyability and satisfactory resolution of formed images. From this viewpoint, preferably the toner particles with a sphericity (DSF) of 0.85 or more constitute 80% by mass or more of the total toner particles and more preferably 85% by mass or more.

Toner is also preferable whose particles have an average roundness (SFR), defined by the following formula II, of 1 to 1.5 and whose surface is coated with a thin film containing a thermosetting resin.

$$SFR = \frac{1}{n} {\sum }_{i = 1}^{n} [ ( {M}_{i}^{2} / {A}_{i} ) \times ( π / 4 ) ] \qquad II$$

As shown in FIGS. 2 and 3, Mi represents the maximum diameter of the i^{th} toner particle drawn in projection, Ai represents the area of the i^{th} toner particle drawn in projection, Σ means summing the values found when i=1 (the first toner particle) to i=n (the n^{th} toner particle), and n represents the number of toner particles selected for calculating the average, which is an integer of 100 or more and, to improve the statistical accuracy, sometimes 200 or more, 500 or more and 1000 or more, depending on the situation. The more the shape of toner is controlled and the higher the roundness of the same becomes, the smaller the value SFR becomes and the closer it becomes to 1.

Use of toner whose particles have a sufficiently high roundness and whose surface is coated with a thermosetting resin makes possible the realization of satisfactory toner conveyability and satisfactory resolution of formed images. From this viewpoint, preferably the toner particles have an average roundness (SFR) of 1.4 or less and more preferably 1.3 or less.

Toner is also preferable whose particles have an average surface unevenness (SFC), defined by the following formula III, of 1 to 1.3 and whose surface is coated with a thin film containing a thermosetting resin.

$$SFC = \frac{1}{n} {\sum }_{i = 1}^{n} [ ( {P}_{i}^{2} / {A}_{i} ) \times ( 1 / 4 π ) ] \qquad III$$

As shown in FIGS. 2 and 3, Pi represents the perimeter of the i^{th} toner particle drawn in projection, Ai represents the area of the i^{th} toner particle drawn in projection, Σ means summing the values found when i=1 (the first toner particle) to i=n (the n^{th} toner particle), and n represents the number of toner particles selected for calculating the average, which is an integer of 100 or more and, to heighten the statistical accuracy, sometimes 200 or more, 500 or more and 1000 or more, depending on the situation. The more the shape of toner is controlled and the lower the surface unevenness of the same becomes, the smaller the value SFC becomes and the closer it becomes to 1.

Use of toner whose particles have less surface unevenness and whose surface is coated with a thermosetting resin makes possible the realization of satisfactory toner conveyability and satisfactory resolution of formed images. From this viewpoint, preferably the toner particles have an average surface unevenness (SFC) of 1.2 or less and more preferably 1.1 or less.

The toner as described above is applicable to both ground toner and polymerized toner; however, ground toner more tends to have low sphericity, low roundness or extreme surface unevenness. Further, comparing ground toner with polymerized toner, generally the production method is easier and production cost is lower in ground toner. For these reasons, applying the present invention to ground toner sometimes produces more remarkable improving effect.

The toner having controlled shape described above can be produced by a method that includes the steps of:
dispersing powder toner in the solid state in a water-base medium where a dispersant is dissolved;
mixing a precursor of a thermosetting resin into the dispersion;
resinifying the precursor of 1 for the thermosetting resin, while avoiding fusing the powder toner, to coat the surface of the powder toner with thin film containing the thermosetting resin; and
heating the powder toner in the temperature range that causes no thermal breakage of the thermosetting resin to fuse the powder toner.

The toner having controlled shape described above can also be produced by a method that includes the steps of:
emulsion polymerizing toner ingredients that comprise binder resin monomer as a raw material for a binder resin to prepare a dispersion of powder toner;
mixing a precursor of a thermosetting resin into the dispersion of the powder toner;
resinifying the precursor of the thermosetting resin, while avoiding fusing the powder toner, to coat the surface of the powder toner with thin film containing the thermosetting resin; and
heating the powder toner in the temperature range that causes no thermal breakage of the thermosetting resin to fuse the powder toner.

In each of the above described production method, the surface-coated toner is heated in the temperature range that causes neither thermal breakage of the thermosetting resin nor substantial leakage of the encapsulated toner ingredients. This heating step allows the encapsulated toner ingredients to be fused and shaped. As a result, the sphericity and roundness of the toner are improved and the surface unevenness of the same is decreased.

Thus, this step can be taken as a step of heat-shaping toner with its surface coated with a thin film and such toner can be shaped into the spherical form conveniently, at low cost and efficiently just through this heat-shaping step.

Preferably, the temperature range that causes neither thermal breakage of a thermosetting resin nor substantial leakage of encapsulated toner ingredients is, for example, the glass transition temperature of the thermosetting resin or lower, specifically 95° C. or lower, more preferably 85° C. or lower and much more preferably 75° C. or lower. When thinking of toner fusible at low temperatures, the temperature range is preferably 80° C. or lower and more preferably 70° C. or lower.

Meanwhile, from the viewpoint of satisfactory shaping of toner by the sufficient fusing of the encapsulated toner ingredients, the temperature range of heat shaping is preferably the softening temperature of toner before thin-film coating or higher. The glass transition temperature of the binder resin of toner or higher is also preferable. Specifically, the temperature range of heat shaping is preferably 35° C. or higher, more preferably 40° C. or higher and much more preferably 45° C. or higher.

Employing any of the above described methods makes it possible to produce toner whose particles have sufficiently high spheicity, sufficiently high roundness and less surface unevenness and whose surface is coated with a thermosetting resin conveniently, at low cost and in good productivity.

Use of toner which is produced by any of the above described methods and whose surface is coated with a thin film composed mainly of a thermosetting resin makes possible the realization of satisfactory toner conveyability and satisfactory resolution of formed images.

To inhibit encapsulated toner ingredients from leaking out in the step of heating and shaping toner, preferably the surface of toner is coated with substantially continuous thin film.

The substantially continuous thin film can be formed by resinifying raw materials for the thin film on the surface of a solid body. Accordingly, toner before and during thin film coating is preferably in the form of powder at ordinary temperature.

Specifically, the surface of toner is coated with such thin film by dispersing powder toner in the solid state in a water-base medium where a dispersant is dissolved, mixing a precursor of a thermosetting resin into the dispersant, and resinifying the precursor of a thermosetting resin on the surface to the toner while avoiding fusing the powder toner.

According to this production method, first toner in the solid state is dispersed in a water-base medium where a dispersant is dissolved. Then, a raw material for a thermosetting resin, which is to become thin film, is added to the above dispersant and resinified on the surface of toner in the solid state. As a result, the individual toner particles can be coated with a thin film of the thermosetting resin. The resultant thermosetting resin film is sufficiently thin and coats the surface of toner substantially continuously.

If the resin thin film is taken as a resin capsule wall, each microcapsule can be taken as a single-core microcapsule that contains a single toner particle. And even if the toner has a low softening temperature, the toner particles can be inhibited from coalescing with each other since the surface of each toner particle is coated with a thermosetting-resin thin wall.

The above described method is available for applying a coating onto either one of ground toner and polymerized toner. However, in polymerized toner produced by emulsion polymerization, for example, if the surface of the polymerized toner is coated with a thermosetting resin subsequently after the emulsion polymerization, the polymerized toner need not undergo separation and purification prior to the coating process, and thus good productivity and performance can be realized.

Specifically, thin-film coated toner as described above can be produced by emulsion polymerizing toner ingredients that include binder resin monomer as a raw material for a binder resin to prepare a dispersion of toner, mixing a precursor of a thermosetting resin into the dispersion of powder toner, and resinifying the precursor of a thermosetting resin, while avoiding fusing the toner, to coat the surface of the toner with thin film containing the thermosetting resin.

The thin-film coated toner is recovered by means of sedimentation, cleaned and heat dried, after coating process, depending on the situation.

Further, the heat dried thin-film coated toner is grinded depending on the situation.

(Binder Resin)

Any binder resins can be used in this invention as long as theyt sufficiently bind the constituents of toner and realize a good fusing property and charging property of toner. Examples of binder resins applicable include: vinyl ether resin, vinyl butylal resin, urethane resin, ester resin, epoxy resin, styrene resin, acrylic resin, olefin resin such as ethylene resin and propylene resin, vinyl acetate resin, vinyl chloride resin, amide resin, vinyltoluenepolymer, maleic acid polymer, phenolic resin, natural modified phenolic resin, natural resin modified maleic resin, silicone resin, furan resin, xylene resin, terpene resin, cumarone-indene resin, petroleum resin, waxes, and copolymers of the monomer ingredients of the above described resins. More than one resin can be used in combination, depending on the situation.

When thinking of flash fusing, of the above described resins, ester resin, styrene resin, acrylic resin, epoxy resin and olefin resin are preferable. Copolymers of the monomers constituting these resins and the alloys of these resins can also be used.

From the viewpoint of resolution of formed images, olefin resin such as ethylene resin and propylene resin are preferable.

In ester resin, for example, as an alcohol ingredient is used
polyoxypropylene(2.2)-2,2-bis(4-hydroxyphenyl)propane,
polyoxypropylene(3.3)-2,2-bis(4-hydroxyphenyl)propane,
polyoxyethylene(2.0)-2,2-bis(4-hydroxyphenyl)propane,
polyoxyethylene(2.2)-2,2-bis(4-hydroxyphenyl)propane,
polyoxypropylene(2.0)-polyoxyethylne(2.0)-2,2-bis(4-hydro xyphenyl)propane, or
polyoxypropylene(6)-2,2-bis(4-hydroxyphenyl)propane.

Depending on the situation, diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol and 1.6-hexanediol; divalent alcohols such as bisphenol A and hydrogenated bisphenol A; and alcohols of trivalent or more such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane and trimethylolpropane can also be used. Two or more of the above described alcohol ingredients can also be used in combination.

As an acid ingredient of ester resin is used terephthalic acid, isophthalic acid, orthophthalic acid or an anhydride thereof; maleic acid, fumaric acid, citraconic acid, itaconic acid, glutaconic acid, cyclohexane dicarboxylic acid, succinic acid, adipic acid, sebacic acid, azelaic acid, malonic acid, n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl sucinic acid, isododecyl succinic acid, isododecenyl succinic acid or an anhydride thereof; or divalent carboxylic acid such as lower alkyl ester. A carboxylic acid ingredient of trivalent or more such as 1,2,4-benzenetricarboxylic acid or 1,3,5-benzenetricarboxylic acid can also be used.

To accelerate the ester resin forming reaction, for example, zinc oxide, stannous oxide, dibutyl tin oxide or dibutyl tin dilaurate can also be used.

Concrete examples of styrene resin and copolymers of the monomer ingredients of styrene resin used include: homopolymers of styrene or styrene derivatives such as polystyrene, poly-p-chlorostyrene and polyvinyltoluene; and styrene copolymers such as styrene-p-chlorostyrene copolymer, styrene-vinyltoluene copolymer, styrene-vinylnaphthalene copolymer, styrene-acrylic ester copolymer, styrene-methacrylic ester copolymer, styrene-methyl α-chloromethacrylate copolymer, styrene-acrylonitrile copolymer, styrene-vinyl methyl ether copolymer, styrene -vinyl ethyl ether copolymer, styrene-vinyl methyl ketone copolymer, styrene-butadiene copolymer, styrene-isoprene copolymer and styrene-acrylonitrile-indene copolymer.

Resins having a crosslinked structure can also be used as a binder resin. As a crosslinking agent for a binder resin, a compound having two or more polymerizable double bonds is used. Concrete examples of such compounds include: aromatic divinyl compounds such as divinylbenzene and divinylnaphthalene; carboxylic esters having two double bonds such as ethylene glycol diacrylate, ethylene glycol dimethacrylate and 1,3-butadiol dimethacrylate; divinyl compounds such as divinyl aniline, divinyl ether, divinyl sulfide and divinyl sulfone; and compounds having three or more vinyl groups. More than one compound can also be used in combination, depending on the situation.

Generally, a binder resin shall constitute 50 to 95% by mass of the entire toner.

To lower the softening temperature of toner, high-boiling (300° C. or higher) oils, low-molecular-weight polypropylene, low-molecular-weight polyethylene, liquid paraffin, fatty acid ester or fatty acid amide can also be added to the above described binder resins in amounts of 0.1 to 20% by mass of the entire toner.

To inhibit toner from softening during the step of coating the toner with resin thin film, the softening temperature of toner is preferably 40° C. or higher, more preferably 50° C. or higher and much more preferably 60° C. or higher. On the other hand, from the viewpoint of ensuring a sufficiently low fusing temperature and realizing high-speed fusing, the softening temperature of toner is preferably 150° C. or lower, more preferably 120° C. or lower and much more preferably 100° C. or lower. The temperature can sometimes be 80° C. or lower. The softening temperature of toner can be measured by ring and ball method or mercury replacement method in accordance with JIS K 7234.

To inhibit toner from softening while it is being coated with urea resin thin film, the softening temperature of toner before surface coating is preferably 30° C. or higher, more preferably 35° C. or higher and much more preferably 40° C. or higher. But on the other hand, from the viewpoint of ensuring a sufficiently low fusing temperature and realizing high-speed fusing, it is preferably 150° C. or lower, more preferably 120° C. or lower and much more preferably 100° C. or lower. The temperature can sometimes be 80° C. or lower.

From the viewpoint of realizing a sufficient anti-blocking property of toner, the softening temperature of toner before surface coating is preferably 40° C. or higher, more preferably 50° C. or higher and much more preferably 60° C. or higher. But on the other hand, from the viewpoint of ensuring a sufficiently low fusing temperature and realizing high-speed fusing, it is preferably 150° C. or lower, more preferably 120° C. or lower and much more preferably 100° C. or lower. The temperature can sometimes be 80° C. or lower.

From the same viewpoints as above, the glass transition temperature (Tg) of the binder resin of toner is preferably 10° C. or higher, more preferably 20° C. or higher and much more preferably 30° C. or higher, and preferably 90° C. or lower, more preferably 80° C. or lower and much more preferably 70° C. or lower.

Toner is divided into two major types: dry toner and wet toner, and dry toner is divided into ground toner and polymerized toner according to its production method.

Ground toner is produced by fully mixing necessary toner ingredients such as a binder resin, coloring material, charge control agent, release agent and magnetic agent with mixer such as Henschel mixer and ball mill.

Then the resultant mixture is fused and kneaded with a heat kneading machine such as heat roll, kneader or extruder to allow a resin ingredient to be compatible with the mixture and disperse the toner ingredients uniformly. The resultant kneaded matter is cooled and hardened, grinded with hammer mill or jet mill, and classified and granulated with cyclone and micron separator to obtain desired toner.

If necessary, a finishing agent etc. can be mixed with mixer such as Henschel mixer.

Meanwhile, polymerized toner can be produced by: for example, a method in which a fused mixture is sprayed into air using a disc, a multi-fluid nozzle, etc. to produce spherical toner particles; a method which uses suspension polymerization to directly produce toner particles; emulsion polymerization such as dispersion polymerization which uses a water-base organic solvent in which monomer is soluble, but polymer is insoluble to directly produce toner particles and soap free polymerization in which monomer is directly polymerized in the presence of a water-soluble polar polymerization initiator to produce toner particles; and a hetero aggregation method in which first primary polar particles are prepared by emulsion polymerization and then oppositely charged polar particles are added to associate the primary polar particles.

Of various production methods, methods are preferable in which a monomer composition that contains polymerizable monomer and other toner ingredients is directly polymerized to produce toner particles. Seed polymerization is also preferable in which polymerized particles obtained are allowed to adsorb monomer and polymerized in the presence of a polymerization initiator.

(Polymerized Toner)

In polymerized toner, preferred toner is such that the surface of its primer particles is coated with a thin film containing a thermosetting resin.

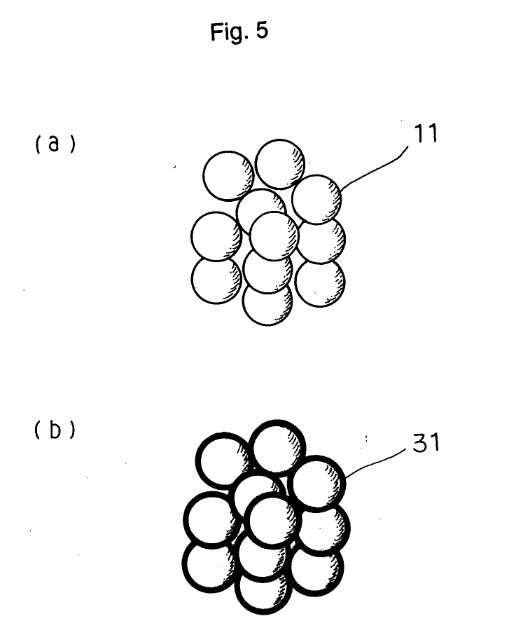

Such polymerized toner, whose surface is coated with a thin film of a thermosetting resin, is produced as shown in FIG. 5 by a method that includes the steps of:
polymerizing toner ingredients that include binder resin monomer as a raw material for a binder resin to prepare a dispersion of toner primary particles 11;
mixing a precursor of a thermosetting resin into the dispersion of the toner primary particles; and
resinifying the precursor of the thermosetting resin, while avoiding fusing the toner primary particles, to coat the surface of the toner primary particles with thin film 31 containing the thermosetting resin.

Preferred toner is also such that the surface of toner secondary particles, which are composed mainly of aggregates of polymerized toner primary particles, is coated with a thin film containing a thermosetting resin.

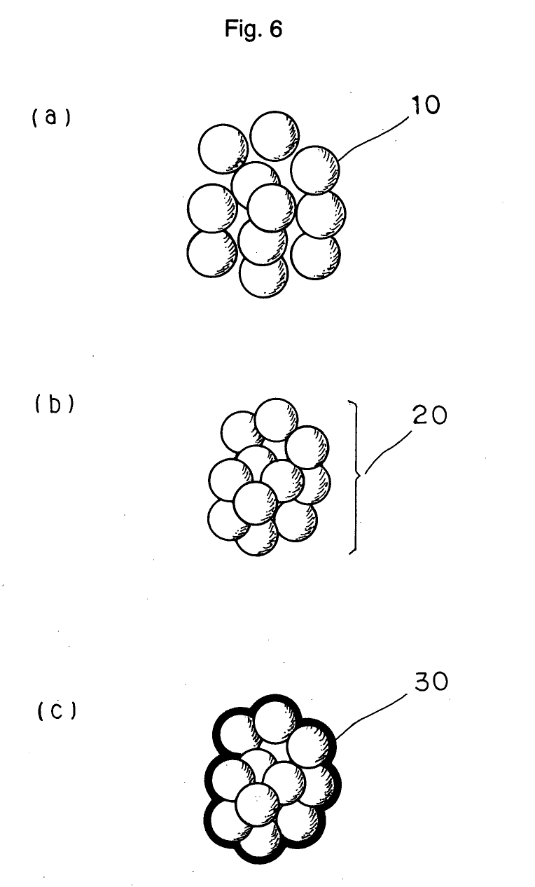

Such polymerized and aggregated toner, whose surface is coated with a thin film of a thermosetting resin, is produced as shown in FIG. 6 by a method that includes the steps of:
polymerizing toner ingredients that include binder resin monomer as a raw material for a binder resin to prepare a dispersion of toner primary particles 10;
aggregating the toner primary particles to prepare a dispersion of toner secondary particles 20;
mixing a precursor of a thermosetting resin into the dispersion of the toner secondary particles; and
resinifying the precursor of the thermosetting resin, while avoiding fusing the toner secondary particles, to coat the surface of the toner secondary particles with thin film 30 containing the thermosetting resin.

Coating the surface of polymerized toner or polymerized and aggregated toner having a sufficiently low softening temperature with a thermosetting resin makes it possible to realize a sufficient anti-blocking property of the toner while avoiding a great increase of the softening temperature of the toner, thereby realizing surface-coated polymerized toner and surface-coated polymerized and aggregated toner that has a low fusing temperature and less blocking tendency at the same time.

Specifically, coating the surface of polymerized toner or polymerized and aggregated toner having a sufficiently low softening temperature with a thermosetting resin makes it possible to keep the fusing temperature increase created by the coating preferably 20° C. or less, more preferably 15° C. or less and much more preferably 10° C. or less.

It also makes it possible to keep the fusing temperature of the thin-film coated toner as an end product preferably 145° C. or less, more preferably 125° C. or less and much more preferably 100° C. or less.

Use of such surface-coated polymerized toner and surface-coated polymerized and aggregated toner, which has a low fusing temperature and less blocking tendency at the same time, makes it possible to realize fusing at a sufficiently low temperature and reduce the thermal energy and time required for fusing, thereby realizing energy-saving and high-speed fusing process.

More specifically, use of such surface-coated polymerized toner or polymerized and aggregated toner makes it possible to realize fusing at a sufficiently low temperature and reduce the thermal energy and time required for fusing, thereby realizing energy-saving and high-speed fusing process in heat fusing methods, such as contact fusing methods using a heat roll etc., non-contact fusing methods such as flash fusing and contact heat pressure fusing methods using a heat pressure roll.

To realize a sufficient anti-blocking property of toner, preferably the surface of toner is coated with substantially continuous thin film.

Substantially continuous coating film can be formed by resinifying a raw material for the film on the surface of a solid body. Thus, toner before and during thin film coating is preferably in the form of powder at ordinary temperature.

Specifically, the surface of toner in the form of powder is coated with a thin film by mixing a precursor of a thermosetting resin into the dispersant of the toner and resinifying the precursor of a thermosetting resin on the surface of the toner, while avoiding fusing the toner.

Even in, for example, toner having a low softening temperature, if thin film coating is formed on the surface of the toner particles, the toner particles can be inhibited from coalescing with each other due to the presence of a thin film thermosetting resin wall on the toner surface.

In the case of polymerized toner produced by emulsion polymerization, suspension polymerization or dispersion polymerization, if the surface of the polymerized toner is coated with a thermosetting resin subsequently after the polymerization, the polymerized toner need not undergo separation and purification prior to the coating process, and thus good productivity and performance can be realized.

The primer particles of polymerized toner can be prepared by emulsion polymerization, suspension polymerization or dispersion polymerization. These types of polymerization are allowed to progress in an appropriate medium using radically polymerizable unsaturated monomer and a radical polymerization initiator, and if necessary, in the presence of a dispersant.

In emulsion polymerization, a water-soluble polymerization initiator is used, whereas in suspension polymerization and dispersion polymerization, an oil-soluble polymerization initiator is used. Examples of water-soluble polymerization initiators used include: persulfates (potassium persulfate, ammonium persulfate, etc.); water-soluble azo initiator (4,4′-azo-bis-(4-cyanovalerianic acid), 2,2′-azo-bis-(2-amidinopropane)dihydrochloride, etc.); and water-soluble peroxide compounds (hydrogen peroxide etc.) Examples of oil-soluble polymerization initiators used include: oil-soluble azo initiator (2,2′-azo-bis-(isobutyronitrile), 2,2′-azo-bis-(2,4-dimethylvaleronitrile), etc.); and oil-soluble peroxide compounds (benzoyl peroxide etc.). These initiators can be used, as a redox initiator, in combination with a reducing agent. Examples of reducing agents used include: meta sodium bisulfite, ferrous chloride and ascorbic acid.

Examples of dispersants used include: surfactants of low-molecular-weight compounds (anionic, cationic and nonionic), surfactants of high-molecular-weight compounds (anionic, cationic and nonionic), polyvinyl alcohol, polyvinyl pyrrolidone and hydroxyalkylcellulose. Colloidal inorganic compounds such as tribasic calcium phosphate, colloidal silica and colloidal alumina are also used. Tribasic calcium phosphate, which is easy to remove after formation of toner particles, is preferable particularly as a dispersant of suspension polymerization.

Examples of monomers used include: styrene compounds such as styrene, p-methylstyrene, o-methylstyrene, p-chlorostyrene, o-chlorostyrene, p-methoxystyrene, o-methoxystyrene, p-ethoxystyrene, p-butoxystyrene, 2,4-dimethylstyrene, 2,4-dichlorostyrene, p-chloromethylstyrene, o-chloromethylstyrene, p-hydroxystyrene and o-hydroxystyrene; acrylic compounds such as methyl (meth)acrylate, ethyl (meth)acrylate, 2-ethylhexyl (meth)acrylate, butyl (meth)acrylate, isobutyl (meth)acrylate, dodecyl (meth)acrylate, stearyl (meth)acrylate, methyl (metha)methacrylate, propyl (metha)methacrylate, isobutyl (metha)methacrylate, n-butyl (metha)methacrylate, 2-ethylhexyl (metha)methacrylate, dodecyl (metha)methacrylate and stearyl (metha)methacrylate; nitrile monomers such as acrylonitrile and methacrylonitrile; vinyl ether monomers such as vinyl methyl ether and vinyl ethyl ether; vinyl ester monomers such as vinyl acetate and vinyl butyrate; olefin monomers such as ethylene, propylene and isobutylene; and conjugated diene such as butadiene, isoprene, chloroprene and dimethylbutadiene.

Monomers having dissociative groups can also be used. Examples of dissociative groups include: carboxyl group, sulfonic acid group, phosphoric acid group, amino group (including primary amine, secondary amine, tertiary amine, etc.), and quaternary ammonium salt. Specifically, examples of monomers having a carboxyl group(s) and used include: acrylic acid, methacrylic acid, maleic acid, itaconic acid, cinnamic acid, fumaric acid, monoalkyl maleate ester and monoalkyl itaconate ester. Examples of monomers having a sulfonic acid group (s) and used include: styrene sulfonic acid, allylsulfosccucinic acid, 2-acrylamide-2-methylpropanesulfonic acid, 2-sulfoethylmethacrylate, and the salts thereof. Examples of monomers having a phosphoric acid group(s) and used include: acid phosphooxyethylmethacrylate, acid phosphooxypropylmethacrylate and 3-chloro-2-acid phosphooxypropylmethacrylate.

Amino group acrylic (methacrylic) acid ester, amide acrylate (methacrylate), amide acrylate (methacrylate) mono- or di-substitutedbyalkyl group(s) having 1 to 18 carbon atoms on its nitrogen atom, vinyl compounds substituted by a heterocycle having a nitrogen atom as a ring member, N,N-diallylalkylamine, and the quaternary ammonium salts thereof can also be used. Concrete examples of acrylic (methacrylic) acid esters used include: dialkylaminoalkyl(meth)acrylate (e.g. dimethylaminoethylacrylate, dimethylaminoethylmethacrylate, diethylaminoethylacrylate and diethylaminoethylmethacrylate) and the acid salts thereof or the quaternary ammonium salts thereof, 3-dimethylaminophenylacrylate, and 2-hydroxy-3-methacryloxypropyltrimethylammonium salt can be used.

Concrete examples of amide acrylate(methacrylate) and amide acrylate (methacrylate) mono- or di-substituted by alkyl group(s) having 1 to 18 carbon atoms on its nitrogen atom used include: (meth)acrylamide, N-butyl(meth)acrylamide, N,N-diethyl (meth) acrylamide, piperazyl (meth) acrylamide and N-octadecylmethacrylamide.

Concrete examples of vinyl compounds substituted by a heterocycle having a nitrogen atom as a ring member, N,N-diallylalkylamine, and the quaternary ammonium salts thereof used include: vinylpyridine, vinylpyrrolidone, vinylimidazol and the quaternary ammonium salts thereof, N,N-diallylmethylammonium chloride and N,N-diallylethylammonium chloride.

Monomers having an active halogen such as vinylbenzyl chloride and vinylphenethyl chloride can also be used.

Sometimes tertiary amines or quaternary ammonium salts are formed using an appropriate amine after polymerization. They can also be copolymerized as a dialkylamine or a quaternary ammonium salt. For example, a dialkylamine can be introduced into vinylbenzyl chloride by monomer reaction or polymer reaction.

Crosslinkable monomers such as divinylbenzene, ethylene glycol dimethacrylate and trimethylolpropane triacrylate are also used, depending on the situation.

Polymer that constitutes polymerized toner primary particles generally has a weight average molecular weight ranging form 1,000 to 1,000,000.

The primary particles of polymerized toner produced as above are aggregated and associated into polymerized toner secondary particles, if necessary, considering the performance required for the toner as an end product, and thin film is applied onto the surface of the toner secondary particles.

The primary particles of polymerized toner are allowed to aggregate and associate by adding an aggregating agent, such as water-soluble polymer, acids, alkalis, water-soluble salts or water-soluble organic solvents, to the dispersion of the polymerized toner primary particles.

As a water-soluble polymer, polyvinyl alcohol, modified polyvinyl alcohol, carboxymethylcellulose or modified carboxymethylcellulose is used.

From the viewpoint of the sufficient aggregation of the primary particles of polymerized toner, the amount of water-soluble polymer used is preferably 0.1 parts by mass or more per 100 parts by mass of the dispersion, whereas from the viewpoint of the other performance of the resultant toner, the amount is preferably 50 parts by mass or less per 100 parts by mass of the dispersion.

As an acid, an organic acid such as acetic acid or acetic acid derivative, or an inorganic acid such as hydrochloric acid or hydrochloric acid derivative is used.

From the viewpoint of the sufficient aggregation of the primary particles of polymerized toner, the amount of acid used is preferably 0.1 parts by mass or more per 100 parts by mass of the dispersion, whereas from the viewpoint of the other performance of the resultant toner, the amount is preferably 50 parts by mass or less per 100 parts by mass of the dispersion.

As an alkali, a basic organic material such as ammonia or ammonia derivative, or a basic inorganic material such as sodium hydroxide, potassium hydroxide or calcium hydroxide is used.

From the viewpoint of the sufficient aggregation of the primary particles of polymerized toner, the amount of alkali used is preferably 0.1 parts by mass or more per 100 parts by mass of the dispersion, whereas from the viewpoint of the other performance of the resultant toner, the amount is preferably 50 parts by mass or less per 100 parts by mass of the dispersion.

As a water-soluble salt, a salt containing a monovalent metal, for example, an alkaline metal such as sodium, potassium and lithium; a salt containing a divalent metal, for example, an alkaline earth metal such as calcium and magnesium, manganese or copper; or a salt containing a trivalent metal, for example, iron and aluminum is used. Concrete examples of salts containing a monovalent metal include: sodium chloride, potassium chloride and lithium chloride. Concrete examples of salts containing a divalent metal include: calcium chloride, zinc chloride, copper sulfate, magnesium sulfate and manganese sulfate. Concrete examples of salts containing a trivalent metal include: aluminum chloride and iron chloride.

From the viewpoint of the sufficient aggregation of the primary particles of polymerized toner, the amount of water-soluble salt used is preferably 0.1 parts by mass or more per 100 parts by mass of the dispersion, whereas from the viewpoint of the other performance of the resultant toner, the amount is preferably 50 parts by mass or less per 100 parts by mass of the dispersion.

As a water-soluble organic solvent used is preferably such that it dissolves in water at 25° C. in amounts of 0.01 parts by mass or more per 100 parts by mass of water. Concrete examples of water-soluble organic solvents used include: alcohols such as methanol, ethanol, propanol, isopropanol, butanol, sec-butanol, isobutanol, pentanol, sec-pentanol, 3-pentanol, 2-methyl-1-butanol, 2-methyl-2-butanol, 3-methyl-1-butanol, 3-methyl-2-butanol, 2,2-dimethyl-1-propanol, cyclohexanol, 1-hexanol, 2-methyl-1-pentanol, 4-methyl-2-pentanol, 2-ethyl-1-butanol, 1-methylcyclohexanol and 2-methylcyclohexanol; nitriles such as acetonitrile, propionitrile, succinonitrile, butylonitrile, isobutylonitrile and benzonitrile; amines such as methylamine, dimethylamine, trimethylamine, ethylamine, diethylamine, triethylamine, pyridine, aniline and imidazole; and acetone.

From the viewpoint of the sufficient aggregation of the primary particles of polymerized toner, the amount of water-soluble organic solvent used is preferably 1 part by volume or more per 100 parts by volume of the dispersion, more preferably 5 parts by volume or more and much more preferably 10 parts by volume or more, whereas from the viewpoint of the other performance of the resultant toner, the amount is preferably 200 parts by volume or less per 100 parts by volume of the dispersion, more preferably 100 parts by volume or less and much more preferably 80 parts by volume or less.

Two or more of the aggregating agents described above can also be used in combination.

The prepared secondary particles of polymerized toner can sometimes be heated. Heating the polymerized toner secondary particles produced by adding an aggregating agent makes it possible to fuse bond the primary particles of polymerized toner and produce more firmly aggregated secondary particles of polymerized toner. Heating the polymerized toner secondary particles produced by adding an aggregating agent also makes it possible to soften the primary particles of polymerized toner and shape the same into secondary particles of polymerized toner.

From this viewpoint, the temperature of such heat treatment is preferably within the range of the glass transition temperature (Tg) of the polymer constituting the primary particles of polymerized toner −10° C. to +50° C.

(Coloring Material)

Any coloring materials can be used as long as they can color toner while avoiding the deterioration of the properties of the toner; however, carbon blacks such as channel carbon and furnace carbon; inorganic pigments such as red oxide, Prussian blue and titanium oxide; azo pigments such as Fast Yellow, disazo yellow, pyrazolone red, chelate red, brilliant carmine and para brown; phthalocyanine pigments such as copper phthalocyanine and metal-free phthalocyanine; condensed polycyclic pigments such as flavanthrone yellow, dibromoanthrone orange, perylene red, quinacridone red and dioxazine violet; disperse dyes; and oil-soluble dyes are used. More than one coloring material can also be used in combination, depending on the situation.

Clay minerals such as calcium carbonate, precipitated barium sulfate, barite powder, white carbon, silica, alumina white, aluminum hydroxide, kaolin and clay and extender pigments such as talc, mica and nepheline syenite can also be used.

In black toner, coloring materials prepared to black by mixing carbon black, a magnetic material, and yellow, magenta and cyan coloring materials shown below are used as black coloring materials.

For color images, yellow toner, magenta toner and cyan toner are produced.

Yellow coloring materials used include: for example, condensed azo compounds, isoindolinone compounds, anthraquinone compounds, azo metal complexes, methyne compounds and allylamide compounds. Concrete examples of yellow coloring materials used are C.I. Pigment Yellow 12, 13, 14, 15, 17, 62, 74, 83, 93, 94, 95, 109, 110, 111, 128, 129, 147, 168 and 180. Dyes such as C.I. Solvent Yellow 93, 162 and 163 may also be used in combination.

Magenta coloring materials used include: for example, condensed azo compounds, diketo-pyrrolo-pyrrole compounds, anthraquinone, quinacridone compounds, basic dye lake compounds, naphthol compounds, benzimidazolone compounds, thioindigo compounds and perylene compounds. Concrete examples are C.I. Pigment Red 2, 3, 5, 6, 7, 23, 48:2, 48:3, 48:4, 57:1, 81:1, 144, 146, 166, 169, 177, 184, 185, 202, 206, 220, 221 and 254.

Cyan coloring materials used include: for example, copper phthalocyanine compounds and the derivatives thereof; anthraquinone compounds and basic dye lake compounds. Concrete examples are C.I. Pigment Blue 1, 7, 15, 15:1, 15:2, 15:3, 15:4, 60, 62 and 66.

In white toner, as white coloring materials are used titanium oxide, titanium white, zinc oxide, zinc white, zinc sulfide, lithopone, basic lead carbonate, antimony white, zirconia and zirconium oxide.

Generally, the amount of coloring material constitutes 1 to 20% by mass of the entire toner.

(Charge Control Agent)

Any charge control agents can be used as long as they can fully control the charge on toner while avoiding the deterioration of the properties of the toner; however, a negative charge control agent and a positive charge control agent are used in this invention.

Concrete examples of negative charge control agents include: organometallic compounds; chelate compounds; monoazo metallic compounds; acetylacetone metallic compounds; aromatic hydroxy carboxylic acid; metallic compounds of aromatic dicarboxylic acid; aromatic hydroxy carboxylic acid; aromatic mono- and poly-carboxylic acid and the metal salts, anhydrides and esters thereof; phenol derivatives such as bisphenol; urea derivatives; metal-containing salicylic acid compounds; metal-containing naphthoic acid compounds; boron compounds; quaternary ammonium salts; calixarene; silicon compounds; styrene-acrylic acid copolymer; styrene-methacrylic acid copolymer; styrene-acryl-sulfonic acid copolymer; and nonmetallic carboxylic acid compounds. Electron accepting dyes such as Cr complex salt dye, electron accepting organic complexes, sulfonyl amine of copper phthalocyanine and chlorinated paraffin are preferable.

Meanwhile, concrete examples of positive charge control agents include: nigrosine; compounds modified by a metallic salt of fatty acid; guanidine compounds; imidazole compounds; tributylbenzineammonium-1-hydroxy-4-naphthosulfonate; quaternary ammonium salts such as tetrabutylammonium tetrafluoroborate; onium salts such as phosphonium salt and lake pigments of quaternary ammonium salts or onium salts; triphenylmethane dye and the lake pigment thereof (examples of laking agents include: phosphotungstic acid, phosphomolybdic acid, phosphotungstic molybdic acid, tannic acid, lauric acid, gallic acid, ferricyanide and ferrocyanide); higher fatty acids; metallic salts of higher fatty acids; diorganotin oxides such as dibutyltin oxide, dioctyltin oxide and dicyclohexyltin oxide; and diorganotin borates such as dibutyltin borate; dioctyltin borate and dicyclohexyltin borate. Electron donating agents such as nigrosine dye and quaternary ammonium salts are preferable.

Generally, the amount of charge control agent constitutes 0.01 to 10% by mass of the entire toner.

(Carrier Ingredient)

Developers are generally divided into two types: two component developers and single component developers. Toner used in a two-component developer ispreparedusing ingredients such as binder resin, coloring material, charge control agent, release agent and finishing agent. And it is mixed with a carrier to form a two-component developer.

Meanwhile, in a single component developer, a carrier ingredient is incorporated into toner together with the other toner ingredients such as binder resin, coloring material, charge control agent, release agent and finishing agent, and such toner is used alone as a developer. The toner for a single component developer is denser than that for a two-component developer, because it includes a carrier ingredient. Accordingly, higher sedimentation speed can be realized in the recovery of thin-film coated toner by sedimentation, which is carried out after the cleaning step, thus thin-film coated toner is satisfactorily recovered and the dispersant used can be easily removed.

From this viewpoint, as a carrier ingredient are used, for example, iron oxides such as magnetite, hematite and ferrite; metal such as iron, cobalt and nickel; the alloys of the above metals and metals such as aluminum, cobalt, copper, lead, magnesium, tin, zinc, antimony, beryllium, bismuth, cadmium, calcium, manganese, selenium, titanium, tungsten and vanadium; the oxides of the above metals; and the mixture thereof. Concrete examples of carrier ingredients used include: metal powders such as iron powder whose surface is oxidized, iron powder whose surface is not oxidized, nickel powder, copper powder, zinc powder, cobalt powder, manganese powder, chromium powder and rare earth powder; oxide powders of these metals; the alloy powders of these metals; oxide powders of these alloys; ferrite powder; and magnetite powder. The amount of these carrier ingredients added constitutes 1 to 60% by mass of the entire toner.

(Toner)

Toner is divided into two major types: dry toner and wet toner, and dry toner is divided into ground toner and polymerized toner according to its production method.

Ground toner is produced by fully mixing necessary toner ingredients such as binder resin, coloring material, charge control agent, release agent and magnetic agent with a mixer such as Henschel mixer and ball mill.

Then the resultant mixture is fused and kneaded with a heat kneading machine such as heat roll, kneader or extruder to allow a resin ingredient to be compatible with the mixture and disperse the toner ingredients uniformly. The resultant kneaded matter is cooled and hardened, grinded with hammer mill or jet mill, and classified and granulated with cyclone and micron separator to obtain desired toner.

If necessary, a finishing agent etc. can be mixed with mixer such as Henschel mixer.

Meanwhile, polymerized toner can be produced by: for example, a method in which a fused mixture is sprayed into air using a disc, a multi-fluid nozzle, etc. to produce spherical toner particles; a method which uses suspension polymerization to directly produce toner particles; emulsion polymerization such as dispersion polymerization which uses a water-base organic solvent in which monomer is soluble, but polymer is insoluble to directly produce toner particles and soap free polymerization in which monomer is directly polymerized in the presence of a water-soluble polar polymerization initiator to produce toner particles; and a hetero aggregation method in which first primary polar particles are prepared by emulsion polymerization and then oppositely charged polar particles are added to associate the primary polar particles.

Of various production methods, methods are preferable in which a monomer composition that contains polymerizable monomer and other toner ingredients is directly polymerized to produce toner particles. Seed polymerization is also preferable in which polymerized particles obtained are allowed to adsorb monomer and polymerized in the presence of a polymerization initiator.

Toner produced as above is mixed with carrier, if necessary. Such mixing is carried out with V blender etc.

Meanwhile, in wet toner, toner ingredients and liquid carrier are fed into a mixing machine such as ball mill or attritor, fully dispersed, and subjected to mixing process and granulating process at the same time.

(Method for Producing Thin-Film Coated Toner)

A step of coating the surface of toner with thin film is carried out in such a state that toner is dispersed in the solid state in a water-base medium where a dispersant is dissolved, or in polymerized toner, it is carried out subsequently after formation of toner particles by emulsion polymerization etc., and therefore, to realize satisfactory thin film coating, selection of a dispersant is important. A dispersant is selected from the viewpoint of sufficient dispersibility of toner, sufficient progress of resinification on the toner surface, and sufficient removability of the dispersant in the cleaning step after thin film formation. If the dispersant used cannot be removed sufficiently in the cleaning step, the particles of produced thin-film coated toner can sometimes coalescing with each other when the toner is dried and heated after cleaning. If thin-film coated toner suffers coalescence, its average particle size and particle size distribution will fall into disorder, and if such thin-film coated toner is forcibly ground, the coating film can sometimes peel off.

From the viewpoint of sufficient dispersibility of toner and sufficient progress of resinification on the toner surface, an anionic dispersant having a carboxyl group or the like is preferably used. And from the viewpoint of sufficient removability of a dispersant in the cleaning step after thin film formation, the dispersant preferably has a molecular weight of 100,000 or less.

More specifically, a high-molecular-weight compound having a weight average molecular weight of 100,000 or less or a low-molecular-weight compound having a molecular weight of 10,000 or less is preferably used. A high-molecular-weight compound having a weight average molecular weight of 10,000 or less or a low-molecular-weight compound having a molecular weight of 1,000 or less is more preferably used.

The viscosity of a 25% by mass solution of a dispersant in water at 25° C., as an index of the molecular weight of the dispersant, is preferably 500 mPa·s or more, more preferably 1,000 mPa·s or more and much more preferably 2,000 mPa·s or more, and at the same time, it is preferably 100,000 mPa·s or less, more preferably 50,000 mPa·s or less and much more preferably 30,000 mPa·s or less.

From the viewpoint of sufficient dispersibility of toner and sufficient progress of resinification on the toner surface, the concentration of a dispersant in the mixture in the step of coating by resinification is preferably 0.1% by mass or more, more preferably 0.5% by mass or more and much more preferably 1% by mass or more, whereas from the viewpoint of sufficient removability of a dispersant in the cleaning step after thin film formation, the concentration is preferably 15% by mass or less, more preferably 12% by mass or less and much more preferably 10% by mass or less. And the concentration can sometimes be 5% by mass or less.

When using a dispersant having a high molecular weight, the concentration of the dispersant is decreased. For example, when using a dispersant having a weight average molecular weight of 100,000 to 1,000,000 or a 25% by mass solution of a dispersant in water whose viscosity is 100,000 to 1000,000 mPa·s at 25° C., the concentration of the dispersant in the mixture in the step of coating by resinification shall be, for example, 0.01 to 0.1% by mass.

Examples of dispersants used include: poly- and oligo-(meth)acrylic acids; copolymer and oligomer of styrene/maleic anhydride partially ring-opened by hydrolysis (ring opening ratio is preferably 30 to 80%); copolymer and oligomer of styrene/maleic anhydride completely ring-opened by hydrolysis; copolymer and oligomer of ethylene/maleic anhydride partially ring-opened by hydrolysis (ring opening ratio is preferably 30 to 80%); copolymer and oligomer of ethylene/maleic anhydride completely ring-opened by hydrolysis; copolymer and oligomer of isobutylene/maleic anhydride partially ring-opened by hydrolysis (ring opening ratio is preferably 30 to 80%); copolymer and oligomer of isobutylene/maleic anhydride completely ring-opened by hydrolysis; poly- and oligo-vinyl alcohols; oligomers derived from hexaethylcellulose; oligomers derived from methylcellulose; oligomers derived from carboxymethylcellulose; sodium benzenesulfonate; alkylbenzenesulfonates such as sodium dodecylbenzenesulfonate; and polyoxyethylenesulfate. Tow or more of these dispersants can be used in combination, depending on the situation.

To inhibit the resinification from abruptly progressing, preferably the temperatures at which toner is dispersed and the raw material for a resin thin film is mixed are made lower than the resinifying temperature at which the raw material is resinified to form coating film. Besides, it is preferable to increase the renifying temperature little by little. Specifically, the dispersing and mixing temperatures are preferably 10 to 40° C. and the resinifying temperature is, in terms of the highest temperature after temperature increase, preferably 40° C. or higher, more preferably 50° C. or higher and much more preferably 60° C. or higher, and at the same time, it is preferably 100° C. or lower, more preferably 90° C. or lower and much more preferably 80° C. or lower.

Preferably, the highest resinifying temperature is lower than the softening temperature of toner.

To inhibit the resinification from abruptly progressing, preferably the mixture for resinification is weakly acid; specifically, the pH of the mixture is about 3 to 6.

The thin-film coated toner obtained as above can be easily recovered by sedimentation in the cleaning step after the coating step, and besides, the dispersant can be easily removed; thus, the particles of the thin-film coated toner hardly coalesce with each other even by heat drying. Thus, the thin-film coated toner can be easily ground after the heat drying step, whereby thin-film coated toner having desired average particle size and particle size distribution can be produced.

(Fusing Method)

As a method for fusing the thin-film coated toner obtained as above, contact fusing methods using a heat roll etc., non-contact fusing method such as flash fusing, and contact heat pressure fusing using a heat pressure roll etc. are suitably used.

In these fusing methods, application of heat causes thermal expansion of the core toner of thin-film coated toner, and hence rupture of the thin film of the same, whereby the core toner is exposed and fused onto a substrate. The amount of thermal energy required for heating is not much more than that required for causing rupture of the thin film, and therefore, if toner having a sufficiently low softening temperature is used as the core toner, high-speed fixing can be realized with low energy consumption. In flash fusing, irradiation of infrared rays causes temperature increase of the core toner momentarily, which causes momentary thermal expansion of the core toner, and hence momentary rupture of the thin film, whereby high-speed fusing can be realized. In pressure fixing, the thin film of thin-film coated toner is ruptured by application of pressure, and therefore, if it is used in combination with heat fusing or flash fusing, high-speed fixing of toner onto a substrate can be realized.

In the above described fusing methods, use of core toner having a low softening temperature makes possible the realization of high-speed fusing with low energy consumption, and even if the core toner used has a low softening temperature, the coalescence of the thin-film coated toner can be inhibited, because the core toner is coated with a thin film.

From the viewpoint of high-speed fusing and energy saving, the fusing temperature of the coated toner as an end product is preferably 145° C. or lower, more preferably 125° C. or lower and much more preferably 100° C. or lower.

In the following, the present invention will be described in detail giving practical examples; however, it is to be understood that the examples described below are not intended to limit the present invention. Unless otherwise specified, reagents used are commercially available high-purity ones.

### Blocking Test

Toner was placed onto a slide glass, and heated for 3 minutes using a hotplate (product name: HHP401) manufactured by Shalman Hotplate Co. The toner on the slide glass was then observed using an SZ-40 (product name) stereoscopic microscope manufactured by Olympus Corporation, and subjected to a picking test using office-use adhesive tape for evaluation of toner blocking tendencies.

### Fixing Test

Forty parts by mass of a 0.1 mass % aqueous sodium dodecylbenzenesulfonate solution (manufactured by Wako Chemical Co., Ltd.) and 10 parts by mass of toner charge control agent, manufactured by Orient Chemical Industries, Ltd., (product name: BONTRON N-01, BONTRON P-51, BONTRON S-34, BONTRON E-84) were measured out. One hundred parts by mass of glass beads (diameter 2 mm) were added, and the resulting mixture was charged into a vessel equipped with a lid. This mixture was ground for 2 hours using a Red Devil 5400 (product name) manufactured by Red Devil Equipment Co. The glass beads were then removed using a 150-mesh sieve to prepare a charge control agent dispersed mixture.

The obtained charge control agent dispersed mixture was added at the end of a thin-film coated toner washing process so that it comprised 0.5 mass % of the entire mixture. The washing operation was then repeated 4 or 5 times to wash the thin-film coated toner. The washed thin-film coated toner was then transferred to a stainless steel vat, and dried for 10 hours in a forced convection drying oven manufactured by Yamato Scientific Co., Ltd., (product name: Fine Oven DH-42) set at 40° C.

The obtained developer was filled into a commercially available copier toner cartridge. A beta image was formed and evaluated for fixing qualities using a measuring instrument manufactured by Macbeth Co., Ltd., (product name: TR 927, R filter).

### EXAMPLE 1-1

### Thin-Film Coated Toner 1-1

A thin film coating was applied onto a commercially available black toner 1-1, which was for a two-component developer for flash fixing. The volume average particle diameter of the black toner 1-1 was 8 μm, its softening temperature was 120° C., the binder resin was an ester and the coloring material was carbon black.

First, a 25 mass % aqueous solution of polyacrylic acid, which had a solution viscosity of 8,000 mPa·s at 25° C., was dissolved in water to prepare an aqueous medium having a pH of 4.5 and a concentration of 5 mass %. One hundred parts by mass of the above-described black toner 1-1 were dispersed at room temperature into 300 parts by mass of the aqueous medium, into which 8.2 parts by mass of hexamethylolmelamine prepolymer (manufactured by Showa Highpolymer Co., Ltd.; product name: Miruben 607) was mixed at room temperature. The resulting room temperature mixture was heated over 20 minutes to 70° C. and subjected to a resinification reaction for 2 hours, whereby the surface of the black toner 1-1 was coated with a melamine resin.

Once the resinification reaction was finished, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 1-1 by a simple pulverizing operation.

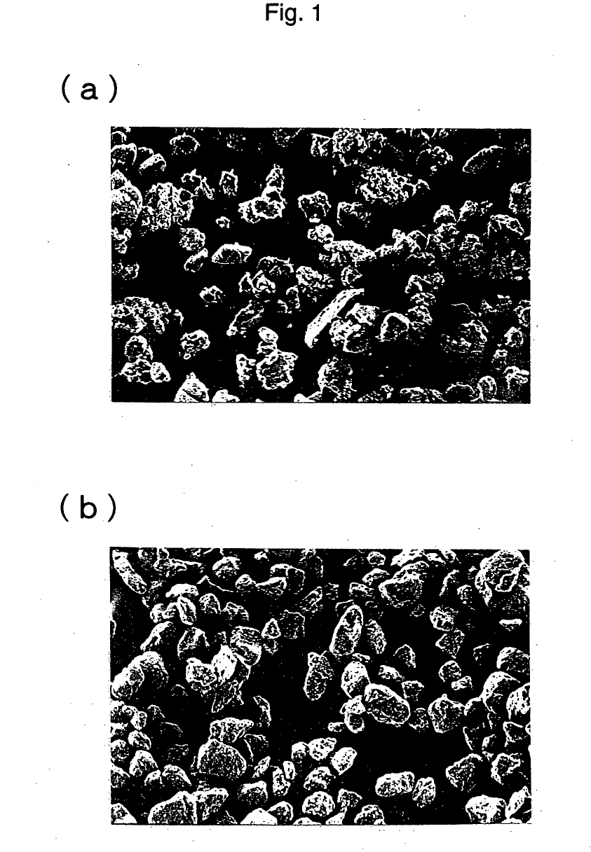

Upon measuring, the obtained thin-film coated toner 1-1 had a volume average particle diameter of 8.05 μm, which suggests that a thin thin-film having an average thickness of 0.03 μm was formed. It was thus learned that the toner average particle diameter did not greatly change from thin film coating. Measurement of the toner particle diameter distribution prior to thin film coating and the toner particle diameter distribution after thin film coating showed that their particle diameter distribution functions were the same, whereby it was learned that the toner particle diameter distribution did also not greatly change from thin film coating. FIG. 1(a) shows an electron micrograph of the toner prior to thin film coating and FIG. 1(b) shows an electron micrograph of the toner after thin film coating. It was learned from these micrographs that the particles of the toner were covered, and that a thin film comprising a thermosetting resin was in essence continuously covering the toner surface.

The thin-film coated toner 1-1 did not show any tendency to coalesce. When a thin layer of the thin-film coated toner 1-1 was formed on paper and irradiated with flash light, the thin film coating was degraded, thereby fixing the thin-film coated toner 1-1 to the paper.

### EXAMPLE 1-2

### Thin-Film Coated Toner 1-2

A thin-film coated toner 1-2 was prepared in the same manner as the thin-film coated toner 1-1, except that a commercially available black toner 1-2 for single component developers comprising magnetite was used in place of the black toner 1-1. The thin-film coated toner 1-2 had particularly good recoverability during centrifugation sedimentation, and had the same or better performance as that of the thin-film coated toner 1-1.

### EXAMPLE 1-3

### Thin-Film Coated Toner 1-3

A thin film coating was applied onto a commercially available black toner 1-3, which was for a two-component developer for flash fixing. The volume average particle diameter of the black toner 1-3 was 8 μm, its softening temperature was 70° C., the binder resin was an ester and the coloring material was carbon black.

First, 300 parts by mass of a 10 mass % ethylene-maleic anhydride copolymer (manufactured by Mosanto; product name: EMA-31), 5 parts by mass of urea and 0.5 parts by mass of resorcinol were mixed together, and the pH was adjusted to 3.2 using aqueous sodium hydroxide. To 300 parts by mass of this solution, 100 parts by mass of the black toner 1-3 were dispersed at room temperature, and then 12.5 parts by mass of formalin were mixed therein at room temperature. The resulting room temperature mixture was heated over 20 minutes to 60° C. and subjected to a resinification reaction for 2 hours, whereby the surface of the black toner 1-3 was coated with a urea-resorcinol resin.

Once the resinification reaction was finished, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the ethylene-maleic anhydride copolymer was removed. The toner washed well.

The thin-film coated toner was then dried by heating at 40° C., wherein there was no occurrence of coalescing or similar problems, to give a thin-film coated toner 1-3 by a simple pulverizing operation.

Upon measuring, the obtained thin-film coated toner 1-3 had a volume average particle diameter of 8.05 μm, which suggests that a thin film having an average thickness of 0.03 μm was formed. It was thus learned that the toner average particle diameter and the toner particle diameter distribution did not greatly change from thin film coating, and that the toner was individually covered and the toner surface was continuously covered.

The thin-film coated toner 1-3 did not show any tendency to coalesce. When a thin layer of the thin-film coated toner 1-3 was formed on paper and irradiated with flash light, the thin film coating was degraded, whereby the thin-film coated toner 1-3 was fixed to the paper.

### EXAMPLE 1-4

### Thin-Film Coated Toner 1-4

A thin-film coated toner 1-4 was prepared in the same manner as the thin-film coated toner 1-3, except that a commercially available black toner 1-2 for single component developers comprising magnetite was used in place of the black toner 1-1. The thin-film coated toner 1-4 had particularly good recoverability during centrifugation sedimentation, and had the same or better performance as that of the thin-film coated toner 1-3.

### EXAMPLE 1-5

### Thin-Film Coated Toner 1-5

A T.K. Homomixer Mark II (product name) manufactured by Tokushu Kika Kogyo Co., Ltd., was used to disperse 100 parts by mass of a commercially available toner for contact fusing (volume average particle diameter 9 μm; softening temperature: 100° C.) in 300 parts by weight of 5 mass % aqueous polyacrylic acid (manufactured by Wako Chemical Co., Ltd.).

To the obtained mixture, 4.2 parts by mass of Miruben Resin 607 (product name), manufactured by Showa Highpolymer Co., Ltd., were slowly added while stirring with a stirrer manufactured by Three-one Motor Co., Ltd. While stirring the temperature was raised from room temperature to 70° C., whereupon after stirring for 2 hours at 70° C., the mixture was cooled to room temperature.

To the obtained slurry containing the thin-film coated toner, 400 parts by mass of distilled water were added and the mixture was stirred until uniform. After stirring, a suitable amount of the mixture was split off into a centrifugal separator tube and processed for 30 minutes at 4000 rpm using a centrifugal separator HIMAG CENTRFUGE CT5DL (product name) made by Hitachi Ltd. After processing, the supernatant was discarded, and the remaining product was washed and dried.

Upon measuring, the obtained thin-film coated toner 1-5 had a volume average particle diameter of 9.05 μm, which suggests that a thin film having an average thickness of 0.03 μm was formed. It was thus learned that the toner average particle diameter and the toner particle diameter distribution did not greatly change from thin film coating, and that the toner was individually covered and the toner surface was continuously covered.

The thin-film coated toner 1-3 did not show any tendency to coalesce. When an image was formed using a contact fusing apparatus equipped with a heat roller, blocking did not occur and high-speed fusing could be realized.

### EXAMPLE 1-6

### Thin-Film Coated Toner 1-6

A thin-film coated toner 1-6 was obtained in the same manner as the thin-film coated toner 1-5, except that a commercially available toner for contact fusing was used (volume average particle diameter: 8 μm; softening temperature: 80° C.) in which the binder resin consisted mainly of polypropylene.

Upon measuring, the obtained thin-film coated toner 1-6 had a volume average particle diameter of 8.05 μm, which suggests that a thin film having an average thickness of 0.03 μm was formed. It was thus learned that the toner average particle diameter and the toner particle diameter distribution did not greatly change from thin film coating, and that the toner was individually covered and the toner surface was continuously covered.

The thin-film coated toner 1-6 did not show any tendency to coalesce. When an image was formed using a contact fusing apparatus equipped with a heat roller, blocking did not occur and high-speed fusing could be realized. In addition, the obtained image possessed a particularly high resolution.

### EXAMPLE 1-7

### Thin-Film Coated Toner 1-7

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis(2,4-dimethylvaleronitrile) were added thereto. Seed polymerization was performed using an acrylic monomer to prepare a polymerized toner.

The polymerized toner was cooled to room temperature, and hexamethylolmelamine prepolymer (manufactured by Showa Highpolymer Co., Ltd.; product name: Miruben 607) was mixed therein at room temperature. The resulting room temperature mixture was heated over 20 minutes to 70° C. and subjected to a resinification reaction for 2 hours, whereby the surface of the polymerized toner was coated with a melamine resin.

Once the resinification reaction was finished, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 1-7 by a simple pulverizing operation.

Upon measuring, the obtained thin-film coated toner 1-7 had a volume average particle diameter of 7 μm, which suggests that a thin thin-film having an average thickness of 0.02 μm (calculated by stoichiometry) was formed. The softening temperature was 80° C. Observation using an electron microscope showed that the toner was individually covered, and that a thin film comprising a thermosetting resin was in essence continuously covering the toner surface.

The thin-film coated toner 1-7 did not show any tendency to coalesce. When a thin layer of the thin-film coated toner 1-7 was formed on paper and irradiated with flash light, the thin film coating was degraded, whereby the thin-film coated toner 1-7 was fixed to the paper.

From the above-described Examples, it was learned that a low tendency to coalesce and high-speed fixing can coexist for a toner when the toner is individually formed into a thin film coating from a resin, whereby a desired average particle diameter and particle distribution can be realized. Further, it was learned that a high resolution could also be realized.

### Average Particle Diameter

The average particle diameter for a toner can be used to calculate number average particle diameter and particle diameter distribution by averaging the calculated diameters of the toner in an image obtained by observing the toner with an electron microscope. Volume average particle diameter and particle diameter distribution can be measured using a method which employs an orifice, a light-scattering method or similar method. If using a method which employs an orifice, measurement can be carried out by using a Coulter multisizer manufactured by Coulter Electronics (U.K.).

### Average Thickness of the Coated Thin-Film

The average thickness of the thin film coated on the toner can be arithmetically calculated from the average particle diameter of a toner prior to coating and the average particle diameter of the toner after coating. Calculation can also be performed by fixing the thin-film coated toner in an epoxy resin or the like, cutting, and observing the cut face with an electron microscope. Calculation can still further be carried out by arithmetic calculation from the amount of raw material consumed in the formation of the thin film and the average particle diameter of the toner.

### Softening Temperature

The softening temperature (° C) can be calculated using a melt extrusion method under a constant applied pressure. In such a method, while raising the temperature of a prescribed amount of a sample, the sample is extruded from a nozzle at a constant applied pressure, whereby the softening temperature is determined from the temperature at which a predetermined amount of material flows out or at which the outflow rate reaches a given value (outflow start temperature). The softening temperature can also be calculated by the ring and ball test according to JIS K 7234.

### Glass Transition Temperature

The glass transition temperature (Tg, ° C.) can be measured by differential scanning calorimetry or a dynamic viscoelasticity analysis. In addition, glass transition temperature (Tg) can also be calculated in accordance with the following experimental formula according to Fox et al.:
1/Tg=Σ(1/Tgi)
wherein Tgi denotes the glass transition of the homoploymer obtained by polymerizing the i^{th} monomer, and Σ denotes taking the sum of i.

### Fusing Test Employing Contact Fusing

A given amount of toner was placed onto a slide glass, and heated for 1 minute at a certain temperature using a hot plate (product name: HHP401) manufactured by Shalman Hotplate Co., Ltd. An industrial use wiper (registered trademark: Kim wipe) manufactured by Crecia Corporation was used to wipe non-fused toner from the slide glass. The amount of toner remaining on the slide after wiping was estimated by visual observation, whereupon the toner using qualities were evaluated based on the following criteria:

A: Most of the toner remained on the slide glass and most of the toner was fused to the slide glass;
B: Half or more of the toner remained on the slide glass and half or more of the toner was fused to the slide glass;
C: Half or more of the toner had been wiped off, whereby half or more of the toner was not fused to the slide glass; and
D: Most of the toner had been wiped off, whereby most of the toner was not fused.

Furthermore, in the above fusing test employing contact fusing, the required minimum temperature for the fusing qualities to be evaluated as an “A” was measured as the fusing temperature (° C)

(Fixing Test Employing Non-Contact Fixing)

A given amount of toner was placed onto commercially available PPC paper, and irradiated with light at a certain lamp intensity (from 0 to 10 levels) using a commercially available xenon flash lamp. After that, office use sellotape (registered trademark) manufactured by Nichiban Co., Ltd., was pasted and then peeled off to adhere and remove non-fixed toner from on the PPC paper. The amount of toner remaining on the PPC paper and the amount of toner adhered to the sellotape after removal was estimated by visual observation, whereupon the toner fixing qualities were evaluated based on the following criteria:
A: Most of the toner remained on the PPC paper, hardly any of the toner had adhered to the sellotape, and most of the toner was fixed to the PPC paper;
B: Half or more of the toner remained on the PPC paper, half or more of the toner had not adhered to the sellotape, and half or more of the toner was fixed to the PPC paper;
C: Half or more of the toner did not remain on the PPC paper, half or more of the toner had adhered to the sellotape, whereby half or more of the toner was not fixed to the PPC paper; and
D: Most of the toner did not remain on the PPC paper, most of the toner had adhered to the sellotape, whereby most of the toner was not fixed to the PPC paper.

### Blocking Test

An obtained toner was subject to shaking and a tap-and-fill procedure to form a layer from 1 to 1.5 cm in thickness. After the layer was heated for 24 hours at 55° C., the blocking tendency of the toner was evaluated according to its tendency to pass through a vibrated sieve having apertures of 180 μm and 63 μm. Specifically evaluated were the mass % (WC) of the coarsest toner that did not pass through 180 μm and remained on the 180 μm sieve, the mass % (WM) of the toner that passed through 180 μm but did not pass through 63 μm, which remained on the 180 μm sieve, and the mass % (WF) of the finest toner that passed through 63 μm and did not remain on any of the sieves.

### Image Forming Ability

Forty parts by mass of aqueous 0.1 mass % sodium dodecylbenzenesulfonate (manufactured by Wako Chemical Co., Ltd.,) and 10 parts by mass of toner charge control agent, manufactured by Orient Chemical Industries, Ltd., (product name: BONTRON N-01, BONTRON P-51, BONTRON S-34, BONTRON E-84) were measured out, to which 100 parts by mass of glass beads (diameter 2 mm) were added. The resulting mixture was charged into a vessel that was equipped with a lid. The mixture was ground for 2 hours using a Red Devil 5400 (product name) manufactured by Red Devil Equipment Co. The glass beads were then removed using a 150-mesh sieve to prepare a charge control agent dispersed mixture.

The obtained charge control agent dispersed mixture was added at the end of the toner washing process so that it was 0.5 mass % of the entire mixture. The washing operation was then repeated 4 or 5 times to wash the thin-film coated toner. The washed thin-film coated toner was then transferred to a stainless steel vat, and dried for 10 hours in a forced convection drying oven manufactured by Yamato Scientific Co., Ltd., (Product name: Fine Oven DH-42) set at 40° C.

The obtained developer was filled into a commercially available copier toner cartridge. A beta image was formed and evaluated for fixing qualities according to the following criteria using a measuring instrument manufactured by Macbeth Co., Ltd., (product name: TR 927, R filter).
A: A high quality image was obtained
B: An image that could stand up to actual use was obtained
C: An image was obtained having a risk of practical defects

### EXAMPLE 2-1

### Urea Resin Thin-Film Coated Toner 2-1

A thin film made from a urea resin was applied in the following manner onto a commercially available fusing toner.

The volume average particle diameter of the employed fusing toner was 8 μm, its softening temperature was 80° C., the binder resin was an ester (glass transition temperature: 45° C.) and the coloring material was carbon black.

First, 1 mole of urea and 2 moles of formaldehyde were condensed at 75° C. in the presence of ammonia to give a viscous syrupy substance. This substance was subjected to vacuum evaporation, and its resin constituent was adjusted to 60 mass % to obtain a concentrated precursor of urea resin. Next, a 25 mass % aqueous solution of polyacrylic acid, which had a solution viscosity of 8,000 mPa·s at 25° C., was dissolved in water to prepare an aqueous medium having a pH of 4.5 and a concentration of 5 mass %. One hundred parts by mass of the fusing toner were dispersed at room temperature into 300 parts by mass of the aqueous medium, into which 1.5 parts by mass of the above-described concentrated precursor of urea resin were mixed at room temperature. The resulting room temperature mixture was heated over 20 minutes to 70° C. and subjected to a resinification reaction for 2 hours, whereby the surface of the fusing toner was coated with a urea resin.

Once the resinification reaction was finished, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a urea resin thin-film coated toner 2-1 by a simple pulverizing operation.

Upon measuring, the obtained urea resin thin-film coated toner 2-1 had a volume average particle diameter of 8.05 μm, which suggests that a thin thin-film having an average thickness of 0.03 μm was formed.

### EXAMPLES 2-2 and 2-3

### Urea Resin Thin-Film Coated Toners 2-2 and 2-3

Urea resin thin-film coated toners 2-2 and 2-3 were prepared in the same manner as the urea resin thin-film coated toner 2-1, except that the average coating thickness was made to be 0.1 μm and 0.6 μm.

A fusing test employing contact fusing was carried out on the urea resin thin-film coated toners 2-1 to 2-3 thus obtained to determine the fusing temperature, melamine resin thin-film coated toners 2-1 to 2-3 prepared by resinification of a hexamethylolmelamine prepolymer on the surface of a fusing toner, and a fusing toner which was not formed with a surface coating. The results are shown in Table 1.

As is clear from Table 1, the urea resin thin-film coated toners 2-1 to 2-3 had the same or approximately the same fusing temperature as the fusing temperature of the flash fusing toners which did not have a surface coating thereon, and could fuse at a lower temperature than the melamine resin thin-film coated toners 2-1 to 2-3.

In addition, a fusing test employing non-contact fusing was carried out on the urea resin thin-film coated toners 2-1, 2-2 and 2-3, melamine resin thin-film coated toners 2-1 to 2-3 prepared by resinification of a hexamethylolmelamine prepolymer on the surface of a fusing toner, and a fusing toner which was not formed with a surface coating. The results are shown in Table 2.

As is clear from Table 2, the urea resin thin-film coated toners 2-1 to 2-3 had the same or approximately the same fixing temperature as the fixing temperature of the flash fusing toners which did not have a surface coating thereon, and could fuse at a lower temperature than the melamine resin thin-film coated toners 2-1 to 2-3.

Furthermore, a blocking test was carried out on the urea resin thin-film coated toners 2-1, 2-2 and 2-3, melamine resin thin-film coated toners 2-1 to 2-3 prepared by resinification of a hexamethylolmelamine prepolymer on the surface of a fusing toner, and a fusing toner which was not formed with a surface coating. The results are shown in Table 3.

As is clear from Table 3, the blocking tendencies of the urea resin thin-film coated toners 2-1 to 2-3 were sufficiently low.

An image forming ability test was carried out on the urea resin thin-film coated toners 2-1 to 2-3, in which the evaluated results for the obtained images were all acceptable; that is, fusing could be carried out at a suitably low temperature, the heat energy necessary for fusing could be obtained, the fusing time could be shortened, and energy conservation and speeding-up of the fusing process could be realized.

TABLE 1
Results of Fusing Test Employing Contact Fusing

| | | | | | | | | Fusing |
|---|---|---|---|---|---|---|---|---|
| | | | | | | | | Temper- |
| | Heating Temperature (° C.) | | | | | | | ature |
| | 80 | 90 | 100 | 110 | 120 | 130 | 140 | (° C.) |
| Urea resin | C | B | A | A | A | A | A | 100 |
| thin-film | | | | | | | | |
| coated | | | | | | | | |
| toner 2-1 | | | | | | | | |
| Urea resin | C | C | B | A | A | A | A | 110 |
| thin-film | | | | | | | | |
| coated | | | | | | | | |
| toner 2-2 | | | | | | | | |
| Urea resin | C | C | B | A | A | A | A | 110 |
| thin-film | | | | | | | | |
| coated | | | | | | | | |
| toner 2-3 | | | | | | | | |
| Melamin | D | D | D | C | B | A | A | 130 |
| resin | | | | | | | | |
| thin-film | | | | | | | | |
| coated | | | | | | | | |
| toner 2-1 | | | | | | | | |
| Melamin | D | D | D | C | C | B | A | 140 |
| resin | | | | | | | | |
| thin-film | | | | | | | | |
| coated | | | | | | | | |
| toner 2-2 | | | | | | | | |
| Melamin | D | D | D | D | D | C | C | 150 |
| resin | | | | | | | | or |
| thin-film | | | | | | | | more |
| coated | | | | | | | | |
| toner 2-3 | | | | | | | | |
| Fusing | C | B | A | A | A | A | A | 100 |
| toner | | | | | | | | |

TABLE 2
Results of Fusing Test Employing Non-contact Heat Fusing

| | Lamp Intensity | | | | | |
|---|---|---|---|---|---|---|
| | Level 0 | Level | Level | Level | Level | Level 10 |
| | (weakest) | 2 | 4 | 6 | 8 | (strongest) |
| Urea resin thin-film | C | A | A | A | A | A |
| coated toner 2-1 | | | | | | |
| Urea resin thin-film | C | B | A | A | A | A |
| coated toner 2-2 | | | | | | |
| Urea resin thin-film | C | C | B | A | A | A |
| coated toner 2-3 | | | | | | |
| Melamin resin | D | D | C | C | B | A |
| thin-film coated | | | | | | |
| toner 2-1 | | | | | | |
| Melamin resin | D | D | D | C | C | B |
| thin-film coated | | | | | | |
| toner 2-2 | | | | | | |
| Melamin resin | D | D | D | D | D | C |
| thin-film coated | | | | | | |
| toner 2-3 | | | | | | |
| Fusing toner | B | A | A | A | A | A |

TABLE 3
Results of Blocking Test

| | W_{C} | W_{M} | W_{F} |
|---|---|---|---|
| | (mass %) | (mass %) | (mass %) |
| Urea resin thin-film coated | 3.0 | 8.5 | 88.5 |
| toner 2-1 | | | |
| Urea resin thin-film coated | 6.4 | 3.2 | 90.4 |
| toner 2-2 | | | |
| Urea resin thin-film coated | 3.6 | 5.1 | 91.3 |
| toner 2-3 | | | |
| Melamin resin thin-film coated | 3.4 | 7.8 | 88.8 |
| toner 2-1 | | | |
| Melamin resin thin-film coated | 2.6 | 6.6 | 90.8 |
| toner 2-2 | | | |
| Melamin resin thin-film coated | 1.8 | 3.0 | 95.2 |
| toner 2-3 | | | |
| Fusing toner | 100 | 0 | 0 |

### EXAMPLE 2-4

### Urea Resin Thin-Film Coated Toner 2-4

A thin film made from a urea resin was applied in the following manner onto a commercially available fusing toner. The volume average particle diameter of the employed fusing toner was 8 μm, its softening temperature was 80° C., the binder resin was an ester (glass transition temperature: 45° C.) and the coloring material was carbon black.

First, a 25 mass % aqueous solution of polyacrylic acid, which had a solution viscosity of 8,000 mPa·s at 25° C., was dissolved in water to prepare a 10 mass % aqueous medium. Three hundred parts by mass of the aqueous medium were mixed with 5 parts by mass of urea, which mixture was adjusted with aqueous sodium hydroxide to give a pH of 3.2. One hundred parts by mass of the fusing toner were dispersed into this mixture at room temperature, into which 12.5 parts by mass of formalin were further mixed at room temperature. The resulting room temperature mixture was heated over 20 minutes to 60° C. and subjected to a resinification reaction for 2 hours, whereby the surface of the fusing toner was coated with a urea resin.

Once the resinification reaction was finished, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a urea resin thin-film coated toner 2-4 by a simple pulverizing operation.

Upon measuring, the obtained urea resin thin-film coated toner 2-4 had a volume average particle diameter of 8.05 μm, which suggests that a thin thin-film having an average thickness of 0.03 μm was formed.

A fusing test employing contact fusing was carried out on the urea resin thin-film coated toner 2-4 thus obtained to determine the fusing temperature. The fusing temperature was 110° C., whereby it was learned that fusing could be carried out at a sufficiently low temperature. When a fixing test was further carried out by non-contact fixing, it was learned that fixing could be carried out at a sufficiently low temperature. When a blocking test employing non-contact fusing was carried out, it was learned that blocking could be sufficiently suppressed.

An image forming ability test was also carried out, in which the evaluated results for the obtained image were all acceptable; that is, fusing could be carried out at a suitably low temperature, the heat energy necessary for fusing could be obtained, the fusing time could be shortened, and energy conservation and speeding-up of the fusing process could be realized.

### EXAMPLE 2-5

### Urea Resin Thin-Film Coated Toner 2-5

A thin film made from a urea resin was applied in the following manner onto a commercially available fusing toner. The volume average particle diameter of the employed fusing toner was 8 μm, its softening temperature was 80° C., the binder resin was an ester (glass transition temperature: 45° C.) and the coloring material was carbon black.

First, a 25 mass % aqueous solution of polyacrylic acid, which had a solution viscosity of 8,000 mPa·s at 25° C., was dissolved in water to prepare a 10 mass % aqueous medium. Three hundred parts by mass of the aqueous medium were mixed with 5 parts by mass of urea and 0.5 parts by mass of hydroquinone, which mixture was adjusted with aqueous sodium hydroxide to give a pH of 3.2. One hundred parts by mass of the fusing toner were dispersed into this mixture at room temperature, into which 12.5 parts by mass of formalin were mixed at room temperature. The resulting room temperature mixture was heated over 20 minutes to 60° C. and subjected to a resinification reaction for 2 hours, whereby the surface of the fusing toner was coated with a urea resin.

Once the resinification reaction was finished, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a urea resin thin-film coated toner 2-5 by a simple pulverizing operation.

Upon measuring, the obtained urea resin thin-film coated toner 2-5 had a volume average particle diameter of 8.05 μm, which suggests that a thin thin-film having an average thickness of 0.03 mw as formed. No defects, such as coloration or the like, were observed.

A fusing test employing contact fusing was carried out on the urea resin thin-film coated toner 2-5 thus obtained to determine the fusing temperature. The fusing temperature was 110° C., whereby it was learned that fusing could be carried out at a sufficiently low temperature. When a fixing test was further carried out by non-contact fixing, it was learned that fixing could be carried out at a sufficiently low temperature. When a blocking test was carried out by non-contact fusing, it was learned that blocking could be sufficiently suppressed.

An image forming ability test was also carried out, in which the evaluated results for the obtained image were all acceptable; that is, fusing could be carried out at a suitably low temperature, the heat energy necessary for fusing could be obtained, the fusing time could be shortened, and energy conservation and speeding-up of the fusing process could be realized.

### EXAMPLE 2-6

### Urea Resin Thin-Film Coated Toner 2-6

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis(2,4-dimethylvaleronitrile) were added thereto. Seed polymerization was performed using an acrylic monomer to prepare a polymerized toner having a volume average particle diameter of 8 μm.

The polymerized toner was cooled to room temperature, whereby a urea resin thin-film coated toner 2-6 was obtained with good productivity, and without isolation of the monomer, in the same manner as the urea resin thin-film coated toner 2-1.

Upon measuring, the obtained thin-film coated toner 2-6 had a volume average particle diameter of 8.05 μm, which suggests that a thin thin-film having an average thickness of 0.03 μm was formed.

A fusing test employing contact fusing was carried out on the urea resin thin-film coated toner 2-6 thus obtained to determine the fusing temperature. The fusing temperature was 110° C., whereby it was learned that fusing could be carried out at a sufficiently low temperature. When a fixing test was further carried out by non-contact fixing, it was learned that fixing could be carried out at a sufficiently low temperature. When a blocking test was carried out by non-contact fusing, it was learned that blocking could be sufficiently suppressed.

An image forming ability test was also carried out, in which the evaluated results for the obtained image were all acceptable; that is, fusing could be carried out at a suitably low temperature, the heat energy necessary for fusing could be obtained, the fusing time could be shortened, and energy conservation and speeding-up of the fusing process could be realized.

From the above, it was learned that blocking resistance and low-temperature fusing can coexist by using a urea resin surface coating toner formed by resinification without fusing of the toner with a concentrated precursor of urea resin at the toner surface.

It was also learned that blocking resistance and low-temperature fixing can coexist by using a urea resin surface coating toner formed by resinification without fusing at the toner surface of the toner with a concentrated precursor of urea resin comprising at least one of urea and a urea derivative and at least one of formaldehyde and a formaldehyde derivative.

### Toner Shape Factors

The toner was observed using an electron microscope, wherein the obtained image was analyzed as a projection chart of the toner for measurement of sphericity (DSF), average roundness (SFR) and average surface unevenness (SFC).

### EXAMPLE 3-1

### Thin-Film Coated Toner 3-1

A thin film made from a melamine resin was applied in the following manner onto a commercially available pulverized fusing toner. The volume average particle diameter of the employed fusing toner was 8 μm, its softening temperature was 80° C., the binder resin was an ester (glass transition temperature: 45° C.) and the coloring material was carbon black.

First, a 25 mass % aqueous solution of polyacrylic acid, which had a solution viscosity of 8,000 mPa·s at 25° C., was dissolved in water to prepare an aqueous medium having a pH of 4.5 and a concentration of 5 mass %. One hundred parts by mass of the above-described fusing toner were dispersed at room temperature into 300 parts by mass of the aqueous medium, into which 8.2 parts by mass of hexamethylolmelamine prepolymer (manufactured by Showa Highpolymer Co., Ltd.; product name: Miruben 607) was mixed at room temperature. The resulting room temperature mixture was heated over 20 minutes to 55° C. and subjected to a resinification reaction for 1 hour, whereby the surface of the fusing toner was coated with a melamine resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 3-1 by a simple pulverizing operation.

Upon measuring, the obtained thin-film coated toner 3-1 had a volume average particle diameter of 8.05 μm, which suggests that a thin thin-film having an average thickness of 0.03 μm was formed. It was thus learned that the toner average particle diameter did not greatly change from thin film coating. Measurement of the toner particle diameter distribution prior to thin film coating and the toner particle diameter distribution after thin film coating showed that their particle diameter distribution functions were the same, whereby it was learned that the toner particle diameter distribution did also not greatly change from thin film coating.

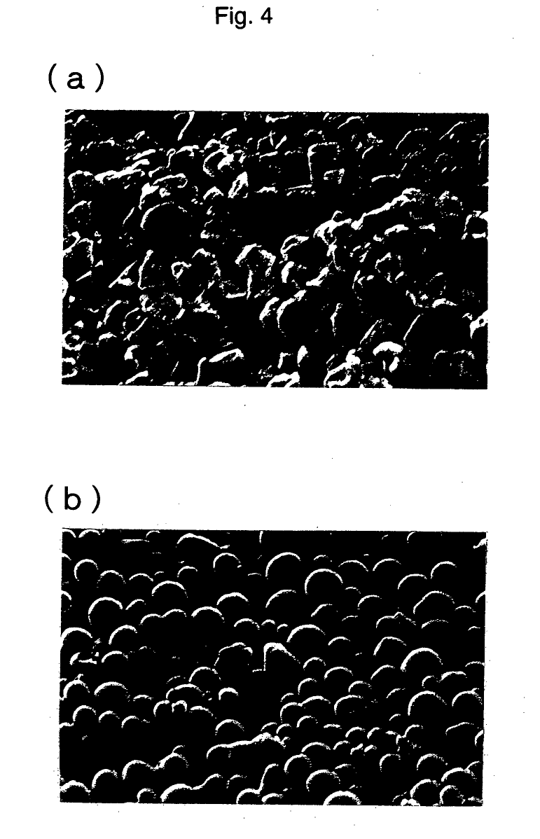

FIG. 4(a) shows an electron micrograph of the toner after thin film coating but prior to thermal molding. FIG. 4(b) shows an electron micrograph of the toner after thermal molding. From these micrographs it was clearly learned that the toner shape was formed in a spherical shape as a result of the thermal molding.

From these micrographs, it was also learned that the toner was individually covered and a thin film consisting of a thermosetting resin continuously covered the toner surface. The fact that the surface coating was continuous was confirmed by the fact that the contained toner did not leak during the toner thermal molding process.

Measurement of the shape factors of the toner prior to thermal molding showed that the share as a whole of the toner which had a sphericity (DSF) of 0.85 or greater was 68% by mass, that average roundness (SFR) was 1.7, and that average surface unevenness (SFC) was 1.4. On the other hand, measurement of the shape factors of the toner after thermal molding showed that the share as a whole of the toner which had a sphericity (DSF) of 0.85 or greater was 87% by mass, that average roundness (SFR) was 1.2, and that average surface unevenness (SFC) was 1.1.

It was learned from the above results that a toner in which the surface is covered by a thermosetting resin, wherein the toner shape can be thermally molded, the sphericity is sufficiently high, average roundness is sufficiently high and surface unevenness is low, can be formed simply, at low cost and at a sufficient productivity by forming on the surface of the toner a surface coating which mainly consists of a thermosetting resin, then fusing a powdered toner with heat within the temperature range where the thermosetting resin is not degraded.

A test was also carried out for image forming ability on the thin-film coated toner 3-1, which showed that the toner possessed sufficient transportability and in which an image having sufficient resolution was obtained, wherein the evaluated results were acceptable.

### EXAMPLE 3-2

### Thin-Film Coated Toner 3-2

A thin film made from a urea resin was applied in the following manner onto a commercially available pulverized fusing toner. The volume average particle diameter of the employed fusing toner was 8 μm, its softening temperature was 80° C., the binder resin was an ester (glass transition temperature: 45° C.) and the coloring material was carbon black.

First, part by 1 mol of urea and 2 parts by mol of formaldehyde were condensed at 75° C. in the presence of ammonia to give a viscous syrupy substance. This substance was subjected to vacuum evaporation, and its resin constituent was adjusted to 60 mass % to obtain a concentrated precursor of urea resin.

Next, a 25 mass % aqueous solution of polyacrylic acid, which had a solution viscosity of 8,000 mPa·s at 25° C., was dissolved in water to prepare an aqueous medium having a pH of 4.5 and a concentration of 5 mass %. One hundred parts by mass of the above-described fusing toner were dispersed at room temperature into 300 parts by mass of the aqueous medium, into which 1.5 parts by mass (dried) of concentrated precursor of urea resin were mixed at room temperature. The resulting room temperature mixture was heated over 20 minutes to 50° C. and subjected to a resinification reaction for 1 hour, whereby the surface of the fusing toner was coated with a urea resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 3-2 by a simple pulverizing operation.

Upon measuring, the obtained thin-film coated toner 3-2 had a volume average particle diameter of 8.05 μm, which suggests that a thin thin-film having an average thickness of 0.03 μm was formed. It was thus learned that the toner average particle diameter did not greatly change from thin film coating. Measurement of the toner particle diameter distribution prior to thin film coating and the toner particle diameter distribution after thin film coating showed that their particle diameter distribution functions were the same, whereby it was learned that the toner particle diameter distribution did also not greatly change from thin film coating.

From electron micrographs before and after thermal molding, it was confirmed that the toner shape was formed in a spherical shape as a result of the thermal molding.

From these micrographs, it was also learned that the toner was individually covered and that a thin film consisting of a thermosetting resin continuously covered the toner surface. The fact that the surface coating was continuous was confirmed by the fact that the contained toner did not leak during the toner thermal molding process.

Measurement of the shape factors of the toner prior to thermal molding showed that the share as a whole of the toner which had a sphericity (DSF) of 0.85 or greater was 68% by mass, that average roundness (SFR) was 1.7, and that average surface unevenness (SFC) was 1.4. On the other hand, measurement of the shape factors of the toner after thermal molding showed that the share as a whole of the toner which had a sphericity (DSF) of 0.85 or greater was 87% by mass, that average roundness (SFR) was 1.2, and that average surface unevenness (SFC) was 1.1.

It was learned from the above results that a toner in which the surface is covered by a thermosetting resin, wherein the toner shape can be thermally molded, the sphericity is sufficiently high, average roundness is sufficiently high and surface unevenness is low, can be formed simply, at low cost and at a sufficient productivity by forming on the surface of the toner a surface coating which mainly consists of a thermosetting resin, then fusing a powdered toner with heat within the temperature range where the thermosetting resin is not degraded.

A test was also carried out for image forming ability on the thin-film coated toner 3-2, which showed that the toner possessed sufficient transportability and in which an image having sufficient resolution was obtained, wherein the evaluated results were acceptable.

### EXAMPLE 3-3

### Thin-Film Coated Toner 3-3

A thin film made from a urea resin was applied in the following manner onto a commercially available pulverized fusing toner. The volume average particle diameter of the employed fusing toner was 8 μm, its softening temperature was 80° C., the binder resin was an ester (glass transition temperature: 45° C.) and the coloring material was carbon black.

First, a 25 mass % aqueous solution of polyacrylic acid, which had a solution viscosity of 8,000 mPa·s at 25° C., was dissolved in water to prep area 10 mass % aqueous medium. Three hundred parts by mass of the aqueous medium were mixed with 5 parts by mass of urea, which mixture was adjusted with aqueous sodium hydroxide to give a pH of 3.2. One hundred parts by mass of the fusing toner were dispersed into this mixture at room temperature, into which 12.5 parts by mass of formalin were further mixed at room temperature. The resulting room temperature mixture was heated over 20 minutes to 60° C. and subjected to a resinification reaction for 1 hour, whereby the surface of the fusing toner was coated with a urea resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 3-3 by a simple pulverizing operation.

Upon measuring, the obtained thin-film coated toner 3-3 had a volume average particle diameter of 8.05 μm, which suggests that a thin thin-film having an average thickness of 0.03 μm was formed. It was thus learned that the toner average particle diameter did not greatly change from thin film coating. Measurement of the toner particle diameter distribution prior to thin film coating and the toner particle diameter distribution after thin film coating showed that their particle diameter distribution functions were the same, whereby it was learned that the toner particle diameter distribution did also not greatly change from thin film coating.

From electron micrographs before and after thermal molding, it was confirmed that the toner shape was formed in a spherical shape as a result of the thermal molding.

From these micrographs, it was also learned that the toner was individually covered and that a thin film consisting of a thermosetting resin continuously covered the toner surface. The fact that the surface coating was continuous was confirmed by the fact that the contained toner did not leak during the toner thermal molding process.

Measurement of the shape factors of the toner prior to thermal molding showed that the share as a whole of the toner which had a sphericity (DSF) of 0.85 or greater was 68% by mass, that average roundness (SFR) was 1.7, and that average surface unevenness (SFC) was 1.4. On the other hand, measurement of the shape factors of the toner after thermal molding showed that the share as a whole of the toner which had a sphericity (DSF) of 0.85 or greater was 87% by mass, that average roundness (SFR) was 1.2, and that average surface unevenness (SFC) was 1.1.

It was learned from the above results that a toner in which the surface is covered by a thermosetting resin, wherein the toner shape can be thermally molded, the sphericity is sufficiently high, average roundness is sufficiently high and surface unevenness is low can be formed simply, at low cost and at a sufficient productivity by forming on the surface of the toner a surface coating which mainly consists of a thermosetting resin, then fusing a powdered toner with heat within the temperature range where the thermosetting resin is not degraded.

A test was also carried out for image forming ability on the thin-film coated toner 3-3, which showed that the toner possessed sufficient transportability and in which an image having sufficient resolution was obtained, wherein the evaluated results were acceptable.

### EXAMPLE 3-4

### Thin-Film Coated Toner 3-4

A thin film made from a urea resin was applied in the following manner onto a commercially available pulverized fusing toner. The volume average particle diameter of the employed fusing toner was 8 μm, its softening temperature was 80° C., the binder resin was an ester (glass transition temperature: 45° C.) and the coloring material was carbon black.

First, a 25 mass % aqueous solution of polyacrylic acid, which had a solution viscosity of 8,000 mPa·s at 25° C., was dissolved in water to prepare a 10 mass % aqueous medium. Three hundred parts by mass of the aqueous medium were mixed with 0.5 parts by mass of urea and 0.5 parts by mass of hydroquinone, which mixture was adjusted with aqueous sodium hydroxide to give a pH of 3.2. One hundred parts by mass of the fusing toner were dispersed into this mixture at room temperature, into which 12.5 parts by mass of formalin were further mixed at room temperature. The resulting room temperature mixture was heated over 20 minutes to 60° C. and subjected to a resinification reaction for 1 hour, whereby the surface of the fusing toner was coated with a urea resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 3-4 by a simple pulverizing operation.

Upon measuring, the obtained thin-film coated toner 3-4 had a volume average particle diameter of 8.05 μm, which suggests that a thin thin-film having an average thickness of 0.03 μm was formed. It was thus learned that the toner average particle diameter did not greatly change from thin film coating. Measurement of the toner particle diameter distribution prior to thin film coating and the toner particle diameter distribution after thin film coating showed that their particle diameter distribution functions were the same, whereby it was learned that the toner particle diameter distribution did also not greatly change from thin film coating.

From electron micrographs before and after thermal molding, it was confirmed that the toner shape was formed in a spherical shape as a result of the thermal molding.

From these micrographs, it was also learned that the toner was individually covered and a thin film consisting of a thermosetting resin continuously covered the toner surface. The fact that the surface coating was continuous was confirmed by the fact that the contained toner did not leak during the toner thermal molding process.

Measurement of the shape factors of the toner prior to thermal molding showed that the share as a whole of the toner which had a sphericity (DSF) of 0.85 or greater was 68% by mass, that average roundness (SFR) was 1.7, and that average surface unevenness (SFC) was 1.4. On the other hand, measurement of the shape factors of the toner after thermal molding showed that the share as a whole of the toner which had a sphericity (DSF) of 0.85 or greater was 87% by mass, that average roundness (SFR) was 1.2, and that average surface unevenness (SFC) was 1.1.

It was learned from the above results that a toner in which the surface is covered by a thermosetting resin, wherein the toner shape can be thermally molded, the sphericity is sufficiently high, average roundness is sufficiently high and surface unevenness is low can be formed simply, at low cost and at a sufficient productivity by forming on the surface of the toner a surface coating which mainly consists of a thermosetting resin, then fusing a powdered toner with heat within the temperature range where the thermosetting resin is not degraded.

A test was also carried out for image forming ability on the thin-film coated toner 3-4, which showed that the toner possessed sufficient transportability and in which an image having sufficient resolution was obtained, wherein the evaluated results were acceptable.

### EXAMPLE 3-5

### Thin-Film Coated Toner 3-5

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto. Seed polymerization was performed using an acrylic monomer to prepare a polymerized toner having a volume average particle diameter of 8 μm.

The polymerized toner was cooled to room temperature, whereby a thin-film coated toner 3-5 was obtained with good productivity, and without isolation of the polymerized toner, in the same manner as the thin-film coated toner 3-2.

Upon measuring, the obtained thin-film coated toner 3-5 had a volume average particle diameter of 8.05 μm, which suggests that a thin thin-film having an average thickness of 0.03 μm was formed.

From electron micrographs it was confirmed that the toner shape was formed in a spherical shape as a result of the thermal molding, that the toner was individually covered and a thin film consisting of a thermosetting resin continuously covered the toner surface. The fact that the surface coating was continuous was confirmed by the fact that the contained toner did not leak during the toner thermal molding process.

Measurement of the shape factors of the thin film toner 3-5 showed that share as a whole of the toner which had a sphericity (DSF) of 0.85 or greater was 87% by mass, that average roundness (SFR) was 1.2, and that average surface unevenness (SFC) was 1.1.

A test was also carried out for image forming ability on the thin-film coated toner 3-5, which showed that the toner possessed sufficient transportability and in which an image having sufficient resolution was obtained, wherein the evaluated results were acceptable.

It was learned from the above results that a toner in which the surface is covered by a thermosetting resin, wherein the toner shape can be thermally molded, the sphericity is sufficiently high, average roundness is sufficiently high and surface unevenness is low, can be formed simply, at low cost and at a sufficient productivity by forming on the surface of the toner a surface coating which mainly consists of a thermosetting resin, then fusing a powdered toner with heat within the temperature range where the thermosetting resin is not degraded. From this, it was learned that a toner having sufficient transportability, and an image having sufficient resolution, can be realized.

### EXAMPLE 4-1-1

### Thin-Film Coated Toner 4-1-1

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared.

A 25 mass % aqueous solution of polyacrylic acid, which had a solution viscosity of 8,000 mPa·s at 25° C., was added to 300 parts by mass of the obtained dispersion of polymerized toner primary particulate to prepare a solution having a pH of 4.5 and a concentration of 5 mass %. Into this solution, 8.2 parts by mass of hexamethylolmelamine prepolymer (manufactured by Showa Highpolymer Co., Ltd.; product name: Miruben 607) was further mixed at room temperature. The resulting room temperature mixture was then raised over 20 minutes to 55° C. and subjected to a resinification reaction for 3 hours, whereby the surface of the fusing toner was coated with a melamine resin.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-1-1 by a simple pulverizing operation.

Upon measuring, the obtained thin-film coated toner 4-1-1 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-1-1, which showed that the toner possessed sufficient transportability, that fixing could be sufficiently carried out at a low temperature, and that a high quality image could be obtained. It was noted that fixing was possible at 100° C.

### EXAMPLE 4-1-2

### Thin-Film Coated Toner 4-1-2

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared.

A 25 mass % aqueous solution of polyacrylic acid, which had a solution viscosity of 8,000 mPa·s at 25° C., was added to 300 parts by mass of the obtained dispersion of polymerized toner primary particulate to prepare a solution having a pH of 4.5 and a concentration of 5 mass %. Into this solution, 8.2 parts by mass of hexamethylolmelamine prepolymer (manufactured by Showa Highpolymer Co., Ltd.; product name: Miruben 607) was further mixed at room temperature. The resulting room temperature mixture was then raised over 20 minutes to 55° C. and subjected to a resinification reaction for 1 hour, whereby the surface of the fusing toner was coated with a melamine resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-1-2 by a simple pulverizing operation.

Upon measuring, the obtained thin-film coated toner 4-1-2 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-1-2, which showed that the toner possessed sufficient transportability, that fixing could be sufficiently carried out at a low temperature, and that a high quality image could be obtained. It was noted that fixing was possible at 100° C.

### Preparation of the Concentrated Precursor of Urea Resin

First, 1 mole of urea and 2 moles of formaldehyde were condensed at 75° C. in the presence of ammonia to give a viscous syrupy substance. This substance was subjected to vacuum evaporation, and its resin constituent was adjusted to 60 mass % to obtain a concentrated precursor of urea resin.

### EXAMPLE 4-2-1

### Thin-Film Coated Toner 4-2-1

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared.

A 25 mass % aqueous solution of polyacrylic acid, which had a solution viscosity of 8,000 mPa·s at 25° C., was added to 300 parts by mass of the obtained dispersion of polymerized toner primary particulate to prepare a solution having a pH of 3.6 and a concentration of 5 mass %. Into this solution, 1.5 parts by mass (dried) of concentrated precursor of urea resin were further mixed at room temperature. The resulting room temperature mixture was then raised over 20 minutes to 55° C. and subjected to a resinification reaction for 3 hours, whereby the surface of the fusing toner was coated with a urea resin.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-2-1 by a simple pulverizing operation.

Upon measuring, the obtained thin-film coated toner 4-2-1 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-2-1, which showed that the toner possessed sufficient transportability, that fixing could be sufficiently carried out at a low temperature, and that a high quality image could be obtained. It was noted that fixing was possible at 100° C.

### EXAMPLE 4-2-2

### Thin-Film Coated Toner 4-2-2

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared.

A 25 mass % aqueous solution of polyacrylic acid, which had a solution viscosity of 8,000 mPa·s at 25° C., was added to 300 parts by mass of the obtained dispersion of polymerized toner primary particulate to prepare a solution having a pH of 3.6 and a concentration of 5 mass %. Into this solution, 1.5 parts by mass (dried) of concentrated precursor of urea resin were further mixed at room temperature. The resulting room temperature mixture was then raised over 20 minutes to 55° C. and subjected to a resinification reaction for 1 hour, whereby the surface of the fusing toner was coated with a urea resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-2-2 by a simple pulverizing operation.

Upon measuring, the obtained thin-film coated toner 4-2-2 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-2-2, which showed that the toner possessed sufficient transportability, that fixing could be sufficiently carried out at a low temperature, and that a high quality image could be obtained. It was noted that fixing was possible at 100° C.

### EXAMPLE 4-3-1

### Thin-Film Coated Toner 4-3-1

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis(2,4-dimethylvaleronitrile) were added thereto to cause polymerization, whereby a polymerized toner primary particulate (glass transition temperature: 45° C.) was prepared.

A 25 mass % aqueous solution of polyacrylic acid, which had a solution viscosity of 8,000 mPa·s at 25° C., was added to 300 parts by mass of the obtained dispersion of polymerized toner primary particulate to prepare a solution having a concentration of 5 mass %. Into this solution, 5 parts by mass of urea were mixed, which mixture was adjusted with aqueous sodium hydroxide to give a pH of 3.2. Into this solution, 12.5 parts by mass of formalin were mixed at room temperature, the resulting mixture being raised over 20 minutes to 60° C. and subjected to a resinification reaction for 3 hours, whereby the surface of the fusing toner was coated with a urea resin.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-3-1 by a simple pulverizing operation.

Upon measuring, the obtained thin-film coated toner 4-3-1 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-3-1, which showed that the toner possessed sufficient transportability, that fixing could be sufficiently carried out at a low temperature, and that a high quality image could be obtained. It was noted that fixing was possible at 100° C.

### EXAMPLE 4-3-2

### Thin-Film Coated Toner 4-3-2

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared.

A 25 mass % aqueous solution of polyacrylic acid, which had a solution viscosity of 8,000 mPa·s at 25° C., was added to 300 parts by mass of the obtained dispersion of polymerized toner primary particulate to prepare a solution having a concentration of 5 mass %. Into this solution, 5 parts by mass of urea were mixed, which mixture was adjusted with aqueous sodium hydroxide to give a pH of 3.2. Into this solution, 12.5 parts by mass of formalin were mixed at room temperature, the resulting mixture being raised over 20 minutes to. 60° C. and subjected to a resinification reaction for 1 hour, whereby the surface of the fusing toner was coated with a urea resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-3-2 by a simple pulverizing operation.

Upon measuring, the obtained thin-film coated toner 4-3-2 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-3-2, which showed that the toner possessed sufficient transportability, that fixing could be sufficiently carried out at a low temperature, and that a high quality image could be obtained. It was noted that fixing was possible at 100° C.

### EXAMPLE 4-4-1

### Thin-Film Coated Toner 4-4-1

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added to prepare a polymerized toner secondary particulate (glass temperature: 45° C.).

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a pH of 4.5 and a concentration of 5 mass %. Into this solution, 8.2 parts by mass of hexamethylolmelamine prepolymer (manufactured by Showa Highpolymer Co., Ltd.; product name: Miruben 607) were mixed at room temperature. The resulting room temperature mixture was heated over 20 minutes to 55° C. and subjected to a resinification reaction for 3 hours, whereby the surface of the fusing toner was coated with a melamine resin.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-4-1 by a simple pulverizing operation.

Upon measuring, the obtained thin-film coated toner 4-4-1 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-4-1, which showed that the toner possessed sufficient transportability, that fixing could be sufficiently carried out at a low temperature, and that a high quality image could be formed. It was noted that fixing was possible at 100° C.

### EXAMPLE 4-4-2

### Thin-Film Coated Toner 4-4-2

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added, and the dispersion was then heated to 80° C. to prepare a polymerized toner secondary particulate (glass temperature: 45° C.).

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a pH of 4.5 and a concentration of 5 mass %. Into this solution, 8.2 parts by mass of hexamethylolmelamine prepolymer (manufactured by Showa Highpolymer Co., Ltd.; product name: Miruben 607) were mixed at room temperature. The resulting room temperature mixture was heated over 20 minutes to 55° C. and subjected to a resinification reaction for 3 hours, whereby the surface of the fusing toner was coated with a melamine resin.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-4-2 by a simple pulverizing operation.

Upon measuring, the obtained thin-film coated toner 4-4-2 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-4-2, which showed that the toner possessed sufficient transportability, that fixing could be sufficiently carried out at a low temperature, and that a high quality image could be formed. It was noted that fixing was possible at 100° C.

### EXAMPLE 4-4-3

### Thin-Film Coated Toner 4-4-3

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis(2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added to prepare a polymerized toner secondary particulate (glass temperature: 45° C.).

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a pH of 4.5 and a concentration of 5 mass %. Into this solution, 8.2 parts by mass of hexamethylolmelamine prepolymer (manufactured by Showa Highpolymer Co., Ltd.; product name: Miruben 607) were mixed at room temperature. The resulting room temperature mixture was heated over 20 minutes to 55° C. and subjected to a resinification reaction for 1 hour, whereby the surface of the fusing toner was coated with a melamine resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-4-3 by a simple pulverizing operation.

Upon measuring, the obtained thin-film coated toner 4-4-3 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-4-3, which showed that the toner possessed sufficient transportability, that fixing could be sufficiently carried out at a low temperature, and that a high quality image could be formed. It was noted that fixing was possible at 100° C.

### EXAMPLE 4-4-4

### Thin-Film Coated Toner 4-4-4

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added, and the dispersion was then heated to 80° C. to prepare a polymerized toner secondary particulate (glass temperature: 45° C.).

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a pH of 4.5 and a concentration of 5 mass %. Into this solution, 8.2 parts by mass of hexamethylolmelamine prepolymer (manufactured by Showa Highpolymer Co., Ltd.; product name: Miruben 607) were mixed at room temperature. The resulting room temperature mixture was heated over 20 minutes to 55° C. and subjected to a resinification reaction for 1 hour, whereby the surface of the fusing toner was coated with a melamine resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-4-4 by a simple pulverizing operation.

Upon measuring, the obtained thin-film coated toner 4-4-4 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-4-4, which showed that the toner possessed sufficient transportability, that fixing could be sufficiently carried out at a low temperature, and that a high quality image could be formed. It was noted that fixing was possible at 100° C.

### EXAMPLES 4-4-5 to 4-4-8

### Thin-Film Coated Toners 4-4-5 to 4-4-8

Thin-film coated toners 4-4-5 to 4-4-8 were each prepared in the same manner as the thin-film coated toners in 4-4-1 to 4-4-4, except that 5 parts by mass of potassium chloride were added in place of the alcohols during preparation of the polymerized toner secondary particulate. A test was also carried out for image forming ability on the obtained toners, which showed that the toners possessed sufficient transportability, that fixing could be sufficiently carried out at a low temperature, and that a high quality image could be obtained. It was noted that fixing was possible at 100° C.

### Preparation of the Concentrated Precursor of Urea Resin

First, 1 mole of urea and 2 moles of formaldehyde were condensed at 75° C. in the presence of ammonia to give a viscous syrupy substance. This substance was subjected to vacuum evaporation, and its resin constituent was adjusted to 60 mass % to obtain a concentrated precursor of urea resin.

### EXAMPLE 4-5-1

### Thin-Film Coated Toner 4-5-1

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added to prepare a polymerized toner secondary particulate (glass temperature: 45° C.)

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a pH of 3.6 and a concentration of 5 mass %. Into this solution, 1.5 parts by mass (dried) of concentrated precursor of urea resin were mixed at room temperature. The resulting room temperature mixture was heated over 20 minutes to 55° C. and subjected to a resinification reaction for 3 hours, whereby the surface of the fusing toner was coated with a urea resin.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-5-1 by a simple pulverizing operation.

Upon measuring, the obtained thin-film coated toner 4-5-1 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-5-1, which showed that the toner possessed sufficient transportability, that fixing could be sufficiently carried out at a low temperature, and that a high quality image could be formed. It was noted that fixing was possible at 100° C.

### EXAMPLE 4-5-2

### Thin-Film Coated Toner 4-5-2

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis(2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added, and the dispersion was then heated to 80° C. to prepare a polymerized toner secondary particulate (glass temperature: 45° C.).

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a pH of 3.6 and a concentration of 5 mass %. Into this solution, 1.5 parts by mass (dried) of concentrated precursor of urea resin were mixed at room temperature. The resulting room temperature mixture was heated over 20 minutes to 55° C. and subjected to a resinification reaction for 3 hours, whereby the surface of the fusing toner was coated with a urea resin.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-5-2 by a simple pulverizing operation.

Upon measuring, the obtained thin-film coated toner 4-5-2 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-5-2, which showed that the toner possessed sufficient transportability, that fixing could be sufficiently carried out at a low temperature, and that a high quality image could be formed. It was noted that fixing was possible at 100° C.

### EXAMPLE 4-5-3

### Thin-Film Coated Toner 4-5-3

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis(2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added to prepare a polymerized toner secondary particulate (glass temperature: 45° C.).

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a pH of 3.6 and a concentration of 5 mass %. Into this solution, 1.5 parts by mass (dried) of concentrated precursor of urea resin were mixed at room temperature. The resulting room temperature mixture was heated over 20 minutes to 55° C. and subjected to a resinification reaction for 1 hour, whereby the surface of the fusing toner was coated with a urea resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-5-3 by a simple pulverizing operation.

Upon measuring, the obtained thin-film coated toner 4-5-3 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-5-3, which showed that the toner possessed sufficient transportability, that fixing could be sufficiently carried out at a low temperature, and that a high quality image could be formed. It was noted that fixing was possible at 100° C.

### EXAMPLE 4-5-4

### Thin-Film Coated Toner 4-5-4

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis(2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added, and the dispersion was then heated to 80° C. to prepare a polymerized toner secondary particulate (glass temperature: 45° C.).

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a pH of 3.6 and a concentration of 5 mass %. Into this solution, 1.5 parts by mass (dried) of concentrated precursor of urea resin were mixed at room temperature. The resulting room temperature mixture was heated over 20 minutes to 55° C. and subjected to a resinification reaction for 1 hour, whereby the surface of the fusing toner was coated with a urea resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-5-4 by a simple pulverizing operation.

Upon measuring, the obtained thin-film coated toner 4-5-4 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-5-4, which showed that the toner possessed sufficient transportability, that fixing could be sufficiently carried out at a low temperature, and that a high quality image could be formed. It was noted that fixing was possible at 100° C.

### EXAMPLES 4-5-5 to 4-5-8

### Thin-Film Coated Toners 4-5-5 to 4-5-8

Thin-film coated toners 4-5-5 to 4-5-8 were each prepared in the same manner as the thin-film coated toners in 4-5-1 to 4-5-4, except that 5 parts by mass of potassium chloride was added in place of the alcohols during preparation of the polymerized toner secondary particulate. A test was also carried out for image forming ability on the obtained toners, which showed that the toner possessed sufficient transportability, that fixing could be sufficiently carried out at a low temperature, and that a high quality image could be obtained. It was noted that fixing was possible at 100° C.

### EXAMPLE 4-6-1

### Thin-Film Coated Toner 4-6-1

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis(2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added to prepare a polymerized toner secondary particulate (glass temperature: 45° C.)

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a concentration of 5 mass %. Into this solution, 5 parts by mass of urea were mixed, which mixture was adjusted with aqueous sodium hydroxide to give a pH of 3.2. Into this solution, 12.5 parts by mass of formalin were mixed at room temperature, the resulting mixture being raised over 20 minutes to 60° C. and subjected to a resinification reaction for 3 hours, whereby the surface of the fusing toner was coated with a urea resin.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-6-1 by a simple pulverizing operation.

Upon measuring, the obtained thin-film coated toner 4-6-1 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-6-1, which showed that the toner possessed sufficient transportability, that fixing could be sufficiently carried out at a low temperature, and that a high quality image could be formed. It was noted that fixing was possible at 100° C.

### EXAMPLE 4-6-2

### Thin-Film Coated Toner 4-6-2

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added, and the dispersion was then heated to 80° C. to prepare a polymerized toner secondary particulate (glass temperature: 45° C.).

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a concentration of 5 mass %. Into this solution, 5 parts by mass of urea were mixed, which mixture was adjusted with aqueous sodium hydroxide to give a pH of 3.2. Into this solution, 12.5 parts by mass of formalin were mixed at room temperature, the resulting mixture being raised over 20 minutes to 60° C. and subjected to a resinification reaction for 3 hours, whereby the surface of the fusing toner was coated with a urea resin.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-6-2 by a simple pulverizing operation.

Upon measuring, the obtained thin-film coated toner 4-6-2 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-6-2, which showed that the toner possessed sufficient transportability, that fixing could be sufficiently carried out at a low temperature, and that a high quality image could be formed. It was noted that fixing was possible at 100° C.

### EXAMPLE 4-6-3

### Thin-Film Coated Toner 4-6-3

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added to prepare a polymerized toner secondary particulate (glass temperature: 45° C.)

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a concentration of 5 mass %. Into this solution, 5 parts by mass of urea were mixed, which mixture was adjusted with aqueous sodium hydroxide to give a pH of 3.2. Into this solution, 12.5 parts by mass of formalin were mixed at room temperature, the resulting mixture being raised over 20 minutes to 60° C. and subjected to a resinification reaction for 1 hour, whereby the surface of the fusing toner was coated with a urea resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-6-3 by a simple pulverizing operation.

Upon measuring, the obtained thin-film coated toner 4-6-3 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-6-3, which showed that the toner possessed sufficient transportability, that fixing could be sufficiently carried out at a low temperature, and that a high quality image could be formed. It was noted that fixing was possible at 100° C.

### EXAMPLE 4-6-4

### Thin-Film Coated Toner 4-6-4

A quinacridone pigment and aluminum di-tert-butyl salicylate were mixed into 100 parts by mass of a styrene monomer and 20 parts by mass of n-butylacrylate monomer. After dispersing for 5 hours, the mixture was heated to 60° C. and 2.3 parts by mass of 2,2′-azobis (2,4-dimethylvaleronitrile) were added thereto to cause polymerization, whereby a polymerized toner primary particulate (glass transition temperature: 45° C.) was prepared that had a volume average particle diameter of 0.7 μm.

A mixture of 15 mL of butyl alcohol and 3 mL of pentyl alcohol was added while stirring to 100 mL of the dispersion of polymerized toner primary particulate. While stirring, 30 mL of isopropyl alcohol was further added, and the dispersion was then heated to 80° C. to prepare a polymerized toner secondary particulate (glass temperature: 45° C.).

The added alcohols were then removed, and a 25 mass % aqueous solution of polyacrylic acid, which had a solution viscosity of 8,000 mPa·s at 25° C., was added to 300 parts by mass of the obtained dispersion of polymerized toner secondary particulate to prepare a solution having a concentration of 5 mass %. Into this solution, 5 parts by mass of urea were mixed, which mixture was adjusted with aqueous sodium hydroxide to give a pH of 3.2. Into this solution, 12.5 parts by mass of formalin were mixed at room temperature, the resulting mixture being raised over 20 minutes to 60° C. and subjected to a resinification reaction for 1 hour, whereby the surface of the fusing toner was coated with a urea resin.

The mixture was then heated to 70° C. and held at that temperature for 2 hours under stirring.

After that, the mixture was cooled to room temperature and the thin-film coated toner was made to sediment by centrifugation for 10 minutes at 4,000 rpm. The thin-film coated toner was recovered by removing the supernatant. The toner sedimented well.

The operation of again suspending in water, subjecting to centrifugation sedimentation and removing the supernatant was repeated on the recovered thin-film coated toner four times, after which the thin-film coated toner was washed and the polyacrylic acid was removed. The toner washed well.

The thin-film coated toner was then dried by heating at 40° C., wherein there was no occurrence of coalescing or similar problems, to give a thin-film coated toner 4-6-4 by a simple pulverizing operation.

Upon measuring, the obtained thin-film coated toner 4-6-4 had a volume average particle diameter of 8 μm, and the average thickness of the thin film was 0.03 μm. The fact that the contained toner did not leak during the toner thermal molding process confirmed that the surface coating was continuous.

A test was also carried out for image forming ability on the thin-film coated toner 4-6-4, which showed that the toner possessed sufficient transportability, that fixing could be sufficiently carried out at a low temperature, and that a high quality image could be formed. It was noted that fixing was possible at 100° C.

### EXAMPLES 4-6-5 to 4-6-8

### Thin-Film Coated Toners 4-6-5 to 4-6-8

Thin-film coated toners 4-6-5 to 4-6-8 were each prepared in the same manner as the thin-film coated toners in 4-6-1 to 4-6-4, except that 5 parts by mass of potassium chloride was added in place of the alcohols during preparation of the polymerized toner secondary particulate. A test was also carried out for image forming ability on the obtained toners, which showed that the toner possessed sufficient transportability, that fixing could be sufficiently carried out at a low temperature, and that a high quality image could be obtained. It was noted that fixing was possible at 100° C.

From the above, it was learned that low blocking tendency and low-temperature fusing can coexist for polymerized toners and polymerized coalesced toners by coating a thermosetting resin on the surface of the polymerized toner and polymer coalesced toner.

In particular, it was learned that low blocking tendency and low-temperature fusing can coexist for polymerized toners and polymerized coalesced toners by coating a thermosetting resin on the surface of the polymerized toner and polymerized coalesced toner to realize sufficient blocking resistance without substantially raising the softening temperature.

Thus, it was learned that fusing can be achieved at a sufficiently low temperature by employing a surface coating polymerized toner and surface coating polymer coalesced toner which has a low softening temperature and low blocking tendency, thereby lowering the heat energy required for fusing and shortening the fusing time, whereby energy saving and acceleration during the fusing process can be realized.

### INDUSTRIAL APPLICABILITY

Coating the surface of a low melting point powder toner with a thermosetting resin makes it possible to realize a satisfactory anti-blocking property of the powder toner, while avoiding increase in softening temperature of the powder toner, which in turn makes it possible to realize toner fusing at lower temperatures. This is particularly effective when using a urea resin as the thermosetting resin or employing polymerized toner as the powder toner. Use of such surface-coated powder toner, that is, powder toner having a low softening temperature and less blocking tendency makes possible the realization of toner fusing at low temperatures, and hence the reduction of the thermal energy and time required for fusing. Thus, energy-saving and high-speed fusing process can be realized.

1. A thin-film coated toner that is a powder toner with a softening temperature ranging from 40 to 150° C. whose surface is coated substantially continuously with the thin film comprising a thermosetting resin.

2. A thin-film coated toner according to claim 1, whose fusing temperature is 145° C. or lower.

3. A thin-film coated toner according to claims 1 or 2, wherein the thermosetting resin is a urea-base resin or a melamine-base resin.

4. A thin-film coated toner according to claim 3, wherein the urea-base resin is formed by resinifying a precursor of a concentrated urea-base resin on the surface of the powder toner while avoiding fusing the powder toner.

5. A thin-film coated toner according to claim 3, wherein the urea-base resin is formed by resinifying a urea-base resin precursor mixture which comprises at least either one of a urea and a urea derivative and at least either one of a formaldehyde and a formaldehyde derivative on the surface of the powder toner, while avoiding fusing the powder toner.

6. A thin-film coated toner according to one of claims 1 to 5, wherein an average film thickness of the thin film is 0.005 to 1 μm.

7. A thin-film coated toner according to one of claims 1 to 6, wherein the powder toner is a polymerized toner.

8. A thin-film coated toner according to claim 7, wherein the polymerized toner is a polymerized toner secondary particle formed by an aggregation of a polymerized toner primary particle.

9. A thin-film coated toner according to one of claims 1 to 8, wherein a true sphericity (DSF) defined by the following formula I is 0.85 or more;
DSF=m/M I
wherein m represents a minimum diameter of a projection drawing of the toner and M represents a maximum diameter of the projection drawing of the same.

10. A method for producing a thin-film coated toner, comprising steps of:
dispersing a powder toner in a solid state in a water-base medium in which a dispersant is dissolved;
mixing a monomer or a pre-polymer of a thermosetting resin into the dispersion; and
resinifying the raw material while avoiding fusing the powder toner, and coating a surface of the powder toner with the thin film comprising the thermosetting resin.

11. A method for producing a thin-film coated toner, comprising steps of:
emulsion-polymerizing a toner ingredient that comprises a binder resin monomer as a raw material for a binder resin to prepare a dispersion of a powder toner;
mixing a monomer of a thermosetting resin or a pre-polymer of a thermosetting resin as a raw material for the thermosetting resin into the dispersion of the powder toner; and
resinifying the monomer of the thermosetting resin or the pre-polymer of the thermosetting resin while avoiding fusing the powder toner, and coating a surface of the powder toner with the thin film comprising the thermosetting resin.

12. A method for producing the thin-film coated toner according to claims 10 or 11, further comprising a step of aggregating the powder toner.

13. A method for producing the thin-film coated toner according to one of claims 10 to 12, further comprising a step of heating the powder toner in a temperature range that causes no thermal breakage of the thin film to fuse the powder toner.
